(19) United States
(12) Patent Application Publication
(10) Pub. No.: US 2025/0179106 A1
(43) Pub. Date: Jun. 5, 2025

(54) Metal Bis(Imino) Aryl Compounds and Methods Thereof

(71) Applicant: EXXONMOBIL CHEMICAL PATENTS INC., Spring, TX (US)

(72) Inventors: Irene C. CAI, Webster, TX (US); Matthew W. HOLTCAMP, Huffman, TX (US); Kevin A. STEVENS, Houston, TX (US); Hua ZHOU, Missouri City, TX (US); Ramyaa MATHIALAGAN, Month Belvieu, TX (US); Xianyi CAO, Pearland, TX (US)

(21) Appl. No.: 18/846,164

(22) PCT Filed: Feb. 20, 2023
(86) PCT No.: PCT/US2023/062896

§ 371 Date: Sep. 11, 2024

Related U.S. Application Data
(60) Provisional application No. 63/319,658, filed on Mar. 14, 2022.

(51) Int. Cl. C07F 15/02; C08F 4/02; C08F 4/70; C08F 210/16

(52) U.S. Cl. CPC C07F 15/025; C08F 4/025; C08F 4/707; C08F 210/16; C08F 2500/05; C08F 2500/07

(57) ABSTRACT

The present disclosure related to metal-containing compounds that, in some embodiments, are alkane-soluble non-metallocene iron compounds having a multidentate ligand chelated to iron, where the multidentate ligand contains at least one nitrogen or phosphorus atom and at least one silyl or germyl group of the formula A(R^{a})(R^{b})(R^{c}) where A is Si or Ge and R^{a}, R^{b}, or R^{c} (such as each of R^{a}, R^{b}, and R^{c}) are independently C₄-C₄₀ alkyl containing a linear or branched chain at least four carbon atoms in length terminally bound to A.

### CROSS-REFERENCE TO RELATED APPLICATION

This application claims the benefit of U.S. Provisional Application 63/319,658 filed on Mar. 14, 2022, entitled “Metal Bis(Imino) Aryl Compounds and Methods Thereof”, the entirety 10 of which is incorporated by reference herein.

### FIELD

The present disclosure relates to 2,6-bis(imino)pyridyl metal compounds, catalyst systems comprising such compounds, and uses thereof.

### BACKGROUND

Olefin polymerization catalysts are of great use in industry and polyolefins are widely used commercially because of their robust physical properties. Hence, there is interest in finding new catalyst systems that increase the marketing value of the catalyst and allow the production of polymers having improved properties.

Useful polyolefins, such as polyethylene, typically have a comonomer, such as hexene, incorporated into the polyethylene backbone. These copolymers provide varying physical properties compared to polyethylene alone and are typically produced in a low pressure reactor, utilizing, for example, solution, slurry, or gas phase polymerization processes. Polymerization may take place in the presence of catalyst systems such as those employing a Ziegler-Natta catalyst, a chromium based catalyst, or a metallocene catalyst. The comonomer content of a polyolefin (e.g., wt % of comonomer incorporated into a polyolefin backbone) influences the properties of the polyolefin (and composition of the copolymers) and is influenced by the polymerization catalyst.

Iron-containing catalysts have been shown to be high activity catalysts capable of forming polyethylene. Typical iron-containing catalysts have a nitrogen atom of a heterocyclic moiety (such as pyridine) that chelates the iron atom. More specifically, iron-containing catalysts are typically tridentate in that they have a pyridyl ligand and two imine ligands that each chelate the iron atom. Chelation of a nitrogen atom of the pyridyl and imine ligands to the iron atom occurs via the lone pair of 7r-electrons on each of the nitrogen atoms. Such iron-containing catalysts, for example 2,6-bis(imino)pyridyl iron(II) dihalide, typically provide low molecular weight polymers. (W. Zhang, et al., Dalton Trans., 2013, 42, pp. 8988-8997; B. L. Small, Acc. Chem. Res., 2015, 48, pp. 2599-2611). Other iron-containing catalysts include 2-[1-(2,6-dibenzhydryl-4-methylphenylimino)ethyl]-6-[1-(aryl-imino)-ethyl]pyridyl iron catalysts.

It is typically difficult for such catalysts to provide a combination of desirable density, melt index, and melt index ratio at desirable catalyst activities. Commonly, such iron-containing catalysts have low/poor solubility in hydrophobic solvents used in polymerizations, such as gas phase polymerizations to form polyethylenes. Without being bound by theory, it is believed that the solubility of the iron-containing catalysts affects the polymerization and ultimately the polymer properties as well, such as the molecular weight, comonomer incorporation, and molecular weight distribution of the polymer products. Moreover, due to the low solubility of iron-containing catalysts in hydrophobic solvents, the use of such catalysts for production of mixed catalyst systems, such as combination with metallocenes, is very limited. In addition, iron catalysts having silyl neopentyl ligands bonded to the iron atom have shown improved solubility as compared to their iron halide counterparts. However, improvements in solubility for iron halide complexes are still needed.

There is a need for catalysts capable of forming polyolefins. In particular, there is a need to develop new and improved metal-containing catalysts with enhanced solubility capable of forming polymers at desirable catalyst activities and the polymers having a high density (>0.94) with a melt index of 0.1 to 20. There is a need for catalysts that can be paired with a second catalyst to produce lower density polyethylene with a density of 0.88 to 0.94.

References for citing in an Information Disclosure Statement (37 CFR 1.97(h)): U.S. 2021/0179650; WO2020096735; Campora, J., Naz, A. M., Palma, P., Álvarez, E. Organometallics, 2005, 24, 4878-4881; EP 2 003 166 A1; WO 2007/080081 A2; U.S. Pat. No. 10,927,204.

### SUMMARY

The present disclosure relates to catalyst compounds represented by Formula (I):

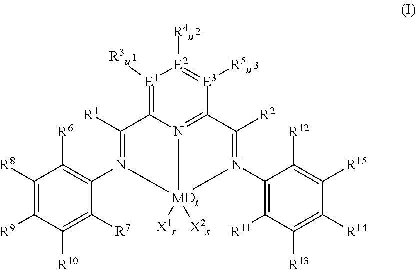

wherein:
   M is a Period 4 transition metal;
   each of R¹ and R² is independently (i) hydrogen, (ii) C₁-C₄₀ hydrocarbyl, (iii) five-, or six-, or seven-membered heterocyclic ring comprising at least one atom selected from the group consisting of N, P, O and S, or (iv) —(R¹⁸)_{q}A(R¹⁹)(R²⁰)(R²¹); wherein each of R¹ and R² is optionally substituted with halogen, —OR¹⁶, or —NR¹⁷₂;
   each of R³, R⁴, R⁵, R⁸, R⁹, R¹⁰, R¹³, R¹⁴, and R¹⁵ is (i) independently hydrogen, (ii) C₁-C₄₀ hydrocarbyl, (iii) —OR¹⁶, (iv) —NR¹⁷₂, (v) halogen, (vi) five-, six-, or seven-membered heterocyclic ring comprising at least one atom selected from the group consisting of N, P, O and S, or (vii) —(R¹⁸)_{q}A(R¹⁹)(R²⁰)(R²¹); wherein R³, R⁴, R⁵, R⁸, R⁹, R¹⁰, R¹³, R¹⁴, and R¹⁵ are optionally substituted with halogen, —OR¹⁶, or —NR¹⁷₂;
   each of R⁶, R7, R¹¹, and R¹² is independently (i) hydrogen, (ii) C₁-C₄₀ hydrocarbyl, or (iii) a heteroatom or a heteroatom-containing group; wherein R⁶, R⁷, R¹¹, and R¹² are optionally substituted with halogen, —OR¹⁶, or —NR¹⁷₂;
   wherein R¹ optionally is bonded to R³, R² optionally is bonded to R⁵, R³ optionally is bonded to R⁴, R⁴ optionally is bonded to R⁵, R⁷ optionally is bonded to R¹⁰, R¹⁰ optionally is bonded to R⁹, R⁹ optionally is bonded to R⁸, R⁸ optionally is bonded to R⁶, R¹⁵ optionally is bonded to R¹⁴, R¹⁴ optionally is bonded to R¹³, R¹³ optionally is bonded to R¹¹, R¹⁵ optionally is bonded to R¹², in each case to independently form a five-, six-, or seven-membered carbocyclic or heterocyclic ring, the heterocyclic ring comprising at least one atom from the group consisting of N, P, O and S;
   each of R¹⁶ and R¹⁷ is independently hydrogen, oxygen, C₁-C₂₂ alkyl, C₂-C₂₂ alkenyl, or C₆-C₂₂ aryl, wherein each R¹⁶ and R¹⁷ is independently optionally substituted with halogen, or two R¹⁶ radicals optionally bond to form a five- or six-membered ring, or two R¹⁷ radicals optionally bond to form a five- or six-membered carbocyclic or heterocyclic ring, the heterocyclic ring comprising at least one atom from the group consisting of N, P, O and S;
   at least one of R¹, R², R³, R⁴, R⁵, R⁶, R⁷, R⁸, R⁹, R¹⁰, R¹¹, R¹², R¹³, R¹⁴, and R¹⁵ is —(R¹⁸)_{q}A(R¹⁹)(R²⁰)(R²¹), wherein: A is Si or Ge; R¹⁸ is C₁-C₁₀ hydrocarbyl; each of R¹⁹, R²⁰, and R²¹ is independently C₁-C₄₀ hydrocarbyl, and q is 0 or 1; wherein R¹⁹ optionally is bonded to R²⁰, R²⁰ optionally is bonded to R²¹, and R¹⁹ optionally is bonded to R²¹, in each case to independently form a five-, six-, or seven-membered carbocyclic or heterocyclic ring, the heterocyclic ring comprising at least one atom from the group consisting of N, P, O and S;
   each of E¹, E², and E³ is independently carbon, nitrogen or phosphorus;
   u¹ is 0 if E¹ is nitrogen or phosphorus, u² is 0 if E² is nitrogen or phosphorus, u³ is 0 if E³ is nitrogen or phosphorus, u¹ is 1 if E^{t} is carbon, u² is 1 if E² is carbon, and u³ is 1 if E³ is carbon,
   each of X¹ and X² is independently an anionic ligand, wherein X¹ optionally is bonded to X² to form a five-, six-, or seven-membered carbocyclic or heterocyclic ring, the heterocyclic ring comprising at least one atom from the group consisting of N, P, O and S;
   r is 1 or 2;
   s is 0 to 2;
   D is a neutral donor;
   t is 0to 2; and
   the sum of r, s, and t is 3 or less.

In yet another embodiment, the present disclosure provides a catalyst system including an activator and a catalyst compound of the present disclosure.

In still another embodiment, the present disclosure provides a polymerization process including contacting one or more olefin monomers with a catalyst system including an activator and a catalyst of the present disclosure.

In still another embodiment, the present disclosure provides a polyolefin formed by a catalyst system and or method of the present disclosure.

### DETAILED DESCRIPTION

Catalyst compounds of the present disclosure are metal-containing compounds including a 2,6-diiminoaryl ligand. Catalyst compounds of the present disclosure can be soluble in hydrophobic (nonpolar) solvents and may be capable of forming polymers having low comonomer content. Catalyst compounds of the present disclosure can provide enhanced solubility and capability of forming polymers at desirable catalyst activities and the polymers having a high density. The improved solubility can be provided by one or more silyl substituents having, for example, ten or more carbon atoms. Surprisingly, such solubility can be realized even with catalysts having halogens bonded to a metal center (such as iron), promoting improved catalyst activity as compared to conventional iron catalysts.

Additionally or alternatively, the molecular weight of polymers formed by catalyst compounds of the present disclosure can be substantially or completely unaffected during a polymerization process in the presence of hydrogen in a polymerization reactor. The inertness of the polymers towards hydrogen makes catalyst compounds of the present disclosure good candidates for use in mixed catalyst systems (e.g., a catalyst system having an iron catalyst and a metallocene catalyst) because the molecular weight of the polymer formed by the second catalyst (e.g., metallocene catalyst) can be tailored using hydrogen in the reactor while the molecular weight of polymers formed by metal-containing catalyst compounds of the present disclosure in the mixed catalyst system remains substantially or completely unaffected by the hydrogen in the reactor. Thus, the molecular weight of the high molecular weight component of the polymer product (of the mixed catalyst system) is tunable while the molecular weight of the low molecular weight component can be substantially or completely unaffected.

In some embodiments, a catalyst compound is an alkane-soluble non-metallocene iron compound comprising a multidentate ligand chelated to iron, where the multidentate ligand contains at least one nitrogen or phosphorus atom and at least one silyl or germyl group of the formula A(R^{a})(R^{b})(R^{c}) where A is Si or Ge and R^{a}, R^{b}, or R^{c} are independently a C₄-C₄₀ alkyl containing a linear or branched chain at least four carbon atoms in length terminally bound to A.

In another class of embodiments, the present disclosure is directed to polymerization processes to produce polyolefin polymers from catalyst systems including one or more olefin polymerization catalysts, at least one activator, and an optional support.

For example, the present disclosure is directed to a polymerization process to produce a polyethylene polymer, the process including contacting a catalyst system including: (1) one or more metal-containing compounds catalysts including a 2,6-diiminoaryl ligand, (2) at least one activator, and (3) optionally at least one support, with ethylene and one or more C₃-C₁₀ alpha-olefin comonomers under polymerization conditions.

As used herein, an “electron deficient side” or “electron withdrawing side” of a catalyst can be a portion of a catalyst that has one or more electron withdrawing groups (such as one, two, three, or more) such that the electron deficient side withdraws electron density toward it and away from an opposing (e.g., electron rich) side of the catalyst.

As used herein, an “electron rich side” or “electron donating side” of a catalyst can be a portion of a catalyst that has one or more electron donating groups (such as one, two, three, or more) such that the electron rich side donates electron density toward an opposing, electron deficient side of the catalyst.

For the purposes of the present disclosure, the numbering scheme for the Periodic Table Groups is used as described in Chemical and Engineering News, 63(5), pg. 27 (1985).

The following abbreviations may be used herein: Me is methyl, Et is ethyl, Ph is phenyl, tBu is tertiary butyl, PDI is polydispersity index, MAO is methylalumoxane, SMAO is supported methylalumoxane, NMR is nuclear magnetic resonance, ppm is part per million, THF is tetrahydrofuran, RPM is revolutions per minute.

As used herein, “olefin polymerization catalyst(s)” refers to any catalyst, such as an organometallic complex or compound that is capable of coordination polymerization addition where successive monomers are added in a monomer chain at the organometallic active center.

The terms “substituent,” “radical,” “group,” and “moiety” may be used interchangeably.

An “olefin,” alternatively referred to as “alkene,” is a linear, branched, or cyclic compound of carbon and hydrogen having at least one double bond. For purposes of this specification, when a polymer or copolymer is referred to as including an olefin, the olefin present in such polymer or copolymer is the polymerized form of the olefin. For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. “Different” is used to refer to mer units indicates that the mer units differ from each other by at least one atom or are different isomerically. Accordingly, the definition of copolymer, as used herein, includes terpolymers. An “ethylene polymer” or “ethylene copolymer” is a polymer or copolymer including at least 50 mol % ethylene derived units, a “propylene polymer” or “propylene copolymer” is a polymer or copolymer including at least 50 mol % propylene derived units, and so on. An “ethylene polymer” or “ethylene copolymer” is a polymer or copolymer including at least 50 mol % ethylene derived units, a “propylene polymer” or “propylene copolymer” is a polymer or copolymer including at least 50 mol % propylene derived units, and so on.

The term “alpha-olefin” refers to an olefin having a terminal carbon-to-carbon double bond in the structure thereof ((R″R′″)—C═CH₂, where R″ and R′″ can be independently hydrogen or any hydrocarbyl group; such as R″ is hydrogen and R′″ is an alkyl group). A “linear alpha-olefin” is an alpha-olefin defined in this paragraph wherein R″ is hydrogen, and R′″ is hydrogen or a linear alkyl group.

For the purposes of the present disclosure, ethylene shall be considered an alpha-olefin.

As used herein, and unless otherwise specified, the term “Cn” means hydrocarbon(s) having n carbon atom(s) per molecule, wherein n is a positive integer. The term “hydrocarbon” means a class of compounds containing hydrogen bound to carbon, and encompasses (i) saturated hydrocarbon compounds, (ii) unsaturated hydrocarbon compounds, and (iii) mixtures of hydrocarbon compounds (saturated and or unsaturated), including mixtures of hydrocarbon compounds having different values of n. Likewise, a “Cₘ-C_{y}” group or compound refers to a group or compound including carbon atoms at a total number thereof from m to y. Thus, a C₁-C₅₀ alkyl group refers to an alkyl group including carbon atoms at a total number thereof of about 1 to about 50.

Unless otherwise indicated, (e.g., the definition of “substituted hydrocarbyl”, “substituted aromatic”, etc.), the term “substituted” means that at least one hydrogen atom has been replaced with at least one non-hydrogen group, such as a hydrocarbyl group, a heteroatom, or a heteroatom containing group, such as halogen (such as Br, Cl, F or I) or at least one functional group (such as —NR*₂, —OR*, —SeR*, —TeR*, —PR*₂, —AsR*₂, —SbR*₂, —SR*, —BR*₂, —SiR*₃, —GeR*3, —SnR*₃, —PbR*₃, where each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted hydrocarbyl” means a hydrocarbyl radical in which at least one hydrogen atom of the hydrocarbyl radical has been substituted with at least one heteroatom (such as halogen, e.g., Br, Cl, F or I) or heteroatom-containing group (such as a functional group, e.g., —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, where each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring. The term “hydrocarbyl substituted phenyl” means a phenyl group having 1, 2, 3, 4 or 5 hydrogen groups replaced by a hydrocarbyl or substituted hydrocarbyl group. For example, the “hydrocarbyl substituted phenyl” group can be represented by the formula:

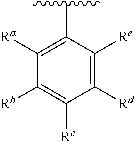

where each of R^{a}, R^{b}, R^{c}, R^{d}, and R^{e} can be independently selected from hydrogen, C₁-C₄₀ hydrocarbyl or C₁-C₄₀ substituted hydrocarbyl, a heteroatom or a heteroatom-containing group (provided that at least one of R^{a}, R^{b}, R^{c}, R^{d}, and R^{e} is hydrocarbyl), or two or more of R^{a}, R^{b}, R^{c}, R^{d}, and R^{e} can be joined together to form a C₄-C₆₂ cyclic or polycyclic hydrocarbyl ring structure, or a combination thereof.

The term “substituted aromatic,” means an aromatic group having 1 or more hydrogen groups replaced by a hydrocarbyl, substituted hydrocarbyl, heteroatom or heteroatom containing group.

The term “substituted phenyl,” mean a phenyl group having 1 or more hydrogen groups replaced by a hydrocarbyl, substituted hydrocarbyl, heteroatom or heteroatom containing group.

The term “substituted naphthyl,” means a naphthyl group having 1 or more hydrogen groups replaced by a hydrocarbyl, substituted hydrocarbyl, heteroatom or heteroatom containing group.

The term “substituted benzyl” means a benzyl group having 1 or more hydrogen groups replaced by a hydrocarbyl, substituted hydrocarbyl, heteroatom or heteroatom containing group, such as a substituted benzyl group is represented by the formula:

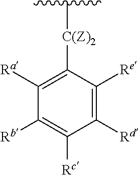

where each of R^{a′}, R^{b′}, R^{c′}, R^{d′}, and R^{e′} and Z is independently selected from hydrogen, C₁-C₄₀ hydrocarbyl or C₁-C₄₀ substituted hydrocarbyl, a heteroatom or a heteroatom-containing group (provided that at least one of R^{a′}, R^{b′}, R^{c′}, R^{d′}, and R^{e′} and Z is not H), or two or more of R^{a′}, R^{b′}, R^{c′}, R^{d′}, R^{e′} and Z are joined together to form a C₄-C₆₂ cyclic or polycyclic ring structure, or a combination thereof.

The terms “hydrocarbyl radical,” “hydrocarbyl group,” or “hydrocarbyl” may be used interchangeably and are defined to mean a group including hydrogen and carbon atoms only. For example, a hydrocarbyl can be a C₁-C₁₀₀ radical that may be linear, branched, or cyclic, and when cyclic, aromatic or non-aromatic. Examples of such radicals may include, but are not limited to, alkyl groups such as methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and aryl groups, such as phenyl, benzyl, naphthyl.

The terms “alkoxy” and “alkoxide” mean an alkyl or aryl group bound to an oxygen atom, such as an alkyl ether or aryl ether group/radical connected to an oxygen atom and can include those where the alkyl/aryl group is a C₁ to C₁₀ hydrocarbyl. The alkyl group may be straight chain, branched, or cyclic. The alkyl group may be saturated or unsaturated. Examples of suitable alkoxy radicals can include methoxy, ethoxy, n-propoxy, iso-propoxy, n-butoxy, iso-butoxy, sec-butoxy, tert-butoxy, phenoxyl.

The term “alkenyl” means a straight-chain, branched-chain, or cyclic hydrocarbon radical having one or more double bonds. These alkenyl radicals may be optionally substituted. Examples of suitable alkenyl radicals can include ethenyl, propenyl, allyl, 1,4-butadienyl, cyclopropenyl, cyclobutenyl, cyclopentenyl, cyclohexenyl, cycloctenyl, including their substituted analogues.

The terms “alkyl radical,” and “alkyl” are used interchangeably throughout this disclosure. For purposes of this disclosure, “alkyl radical” is defined to be C₁-C₁₀₀ alkyls that may be linear, branched, or cyclic. Examples of such radicals can include methyl, ethyl, n-propyl, isopropyl, n-butyl, isobutyl, sec-butyl, tert-butyl, pentyl, iso-amyl, hexyl, octyl, cyclopropyl, cyclobutyl, cyclopentyl, cyclohexyl, cyclooctyl, including their substituted analogues.

The term “aryl” or “aryl group” means an aromatic ring and the substituted variants thereof, such as phenyl, 2-methyl-phenyl, xylyl, 4-bromo-xylyl. Likewise, heteroaryl means an aryl group where a ring carbon atom (or two or three ring carbon atoms) has been replaced with a heteroatom, such as N, O, or S. As used herein, the term “aromatic” also refers to pseudoaromatic heterocycles which are heterocyclic substituents that have similar properties and structures (nearly planar) to aromatic heterocyclic ligands, but are not by definition aromatic; likewise the term aromatic also refers to substituted aromatics.

Unless stated otherwise, description of a moiety (e.g., hydrocarbyl, alkyl, aryl, etc.) embraces unsubstituted and substituted forms of the moiety. Unless otherwise indicated, a “Cₘ-C_{y}” moiety refers to the corresponding unsubstituted moiety including carbon atoms at a total number thereof from m to y, which can be further substituted with one or more heteroatom-containing groups containing additional carbons (such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃), such that the “Cₘ-C_{y}” moiety, if substituted with one or more heteroatom-containing groups containing additional carbons, possibly includes carbon atoms at a total number exceeding y (for instance, a C₄₀ hydrocarbyl could be substituted at one carbon with —N(CH₃)₂ in place of H on said carbon, such that the total number of carbon atoms in this example moiety would be 42). Thus, more generally, a “C₁-C₄₀ hydrocarbyl”, without further specification, refers to an unsubstituted hydrocarbyl group including carbon atoms at a total number thereof of about 1 to about 40, which optionally can be further substituted with one or more heteroatom-containing groups which also contain additional carbons, such that the base C₁-C₄₀ hydrocarbyl group, if substituted, possibly includes carbon atoms at a total number exceeding 40.

Where isomers of a named alkyl, alkenyl, alkoxide, or aryl group exist (e.g., n-butyl, iso-butyl, sec-butyl, and tert-butyl), reference to an alkyl, alkenyl, alkoxide, or aryl group without specifying a particular isomer (e.g., butyl) expressly discloses all isomers (e.g., n-butyl, iso-butyl, sec-butyl, and tert-butyl).

The term “ring atom” means an atom that is part of a cyclic ring structure. By this definition, a benzyl group has six ring atoms and tetrahydrofuran has five ring atoms.

A heterocyclic ring is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom-substituted ring. Other examples of heterocycles may include pyridine, imidazole, and thiazole.

As used herein, Mn is number average molecular weight, Mw is weight average molecular weight, and Mz is z average molecular weight, wt % is weight percent, and mol % is mole percent. Molecular weight distribution (MWD), also referred to as polydispersity (PDI), is defined to be Mw divided by Mn. Unless otherwise noted, all molecular weight units (e.g., Mw, Mn, Mz) are g/mol.

Unless otherwise noted all melting points (Tm) are differential scanning calorimetry (DSC) first melt.

The terms “catalyst compound”, “catalyst complex”, “transition metal complex”, “transition metal compound”, “precatalyst compound”, and “precatalyst complex” are used interchangeably.

A “catalyst system” is a combination of at least one catalyst compound, at least one activator, an optional coactivator, and an optional support material. When “catalyst system” is used to describe such a pair before activation, it means the unactivated catalyst complex (precatalyst) together with an activator and, optionally, a coactivator. When it is used to describe such a pair after activation, it means the activated complex and the activator or other charge-balancing moiety. The catalyst compound may be neutral as in a precatalyst, or a charged species with a counter ion as in an activated catalyst system. For the purposes of the present disclosure and the claims thereto, when catalyst systems are described as including neutral stable forms of the components, it is well understood by one of ordinary skill in the art, that the ionic form of the component is the form that reacts with the monomers to produce polymers. A polymerization catalyst system is a catalyst system that can polymerize monomers to polymer. Furthermore, catalyst compounds and activators represented by formulae herein are intended to embrace both neutral and ionic forms of the catalyst compounds and activators.

An “anionic ligand” is a negatively charged ligand which donates one or more pairs of electrons to a metal ion. A “Lewis base” is a neutrally charged ligand which donates one or more pairs of electrons to a metal ion. Examples of Lewis bases include ethylether, trimethylamine, pyridine, tetrahydrofuran, dimethylsulfide, and triphenylphosphine. The term “heterocyclic Lewis base” refers to Lewis bases that are also heterocycles. Examples of heteroyclic Lewis bases include pyridine, imidazole, thiazole, and furan.

A scavenger is a compound that can be added to facilitate polymerization by scavenging impurities. Some scavengers may also act as activators and may be referred to as coactivators. A coactivator, that is not a scavenger, may also be used in conjunction with an activator in order to form an active catalyst. In at least one embodiment, a coactivator can be pre-mixed with the transition metal compound to form an alkylated transition metal compound.

The term “continuous” means a system that operates without interruption or cessation for an extended period of time. For example a continuous process to produce a polymer would be one where the reactants are continually introduced into one or more reactors and polymer product is continually withdrawn.

As used herein, a “composition” includes the components of the composition and/or one or more reaction products of two or more of the components of the composition.

A solution polymerization means a polymerization process in which the polymer is dissolved in a liquid polymerization medium, such as an inert solvent or monomer(s) or their blends. A solution polymerization can be homogeneous. A homogeneous polymerization is one where the polymer product is dissolved in the polymerization medium. Suitable systems may be not turbid as described in J. Vladimir Oliveira, C. Dariva and J. C. Pinto, Ind. Eng. Chem. Res., 2000, Vol. 29, p. 4627.

A bulk polymerization means a polymerization process in which the monomers and or comonomers being polymerized are used as a solvent or diluent using little or no inert solvent as a solvent or diluent. A small fraction of inert solvent might be used as a carrier for catalyst and scavenger. A bulk polymerization system contains less than 25 wt % of inert solvent or diluent, such as less than 10 wt %, such as less than 1 wt %, such as 0 wt %.

### Catalyst Compounds

In at least one embodiment, the present disclosure provides metal-containing catalysts having an aryl ligand.

In some embodiments, a catalyst compound is an alkane-soluble non-metallocene iron compound comprising a multidentate ligand chelated to iron, where the multidentate ligand contains at least one nitrogen or phosphorus atom and at least one silyl or germyl group of the formula A(R^{a})(R^{b})(R^{c}) where A is Si or Ge and R^{a}, R^{b}, or R^{c} are independently a C₄-C₄₀ alkyl containing a linear or branched chain at least four carbon atoms in length terminally bound to A.

The present disclosure relates to catalyst compounds represented by Formula (I):

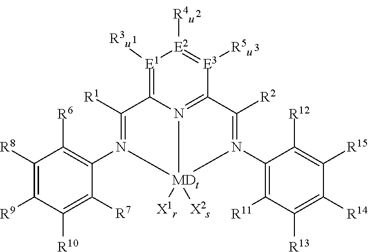

wherein:
   M is a Period 4 transition metal (such as Fe or Co);
   each of R¹ and R² is independently (i) hydrogen, (ii) C₁-C₄₀ hydrocarbyl (such as C₁-C₂₂ alkyl, C₂-C₂₂ alkenyl, C₆-C₂₂ aryl), (iii) five-, or six-, or seven-membered heterocyclic ring comprising at least one atom selected from the group consisting of N, P, O and S, or (iv) —(R¹⁸)_{q}A(R¹⁹)(R²⁰)(R²¹); wherein each of R¹ and R² is optionally substituted with halogen, —OR¹⁶, or —NR¹⁷₂; wherein R¹ optionally is bonded to R³, and R² optionally is bonded to R⁵, in each case to independently form a five-, six-, or seven-membered carbocyclic or heterocyclic ring, the heterocyclic ring comprising at least one atom from the group consisting of N, P, O and S;
   each of R³, R⁴, R⁵, R⁸, R⁹, R¹⁰, R¹³, R¹⁴, and R¹⁵ is independently (i) hydrogen, (ii) C₁-C₄₀ hydrocarbyl (such as C₁-C₂₂ alkyl, C₂-C₂₂ alkenyl, C₆-C₂₂ aryl), (iii) —OR¹⁶, (iv) —NR¹⁷₂, (v) halogen, (vi) five-, six-, or seven-membered heterocyclic ring comprising at least one atom selected from the group consisting of N, P, O and S, or (vii) —(R¹⁸)_{q}A(R¹⁹)(R²⁰)(R²¹);
   wherein R³, R⁴, R⁵, R⁸, R⁹, R¹⁰, R¹³, R¹⁴, and R¹⁵ are optionally substituted with halogen, —OR¹⁶, or —NR¹⁷₂; wherein R³ optionally is bonded to R⁴, R⁴ optionally is bonded to R⁵, R⁷ optionally is bonded to R¹⁰, R¹⁰ optionally is bonded to R⁹, R⁹ optionally is bonded to R⁸, R⁸ optionally is bonded to R⁶, R¹⁵ optionally is bonded to R¹⁴, R¹⁴ optionally is bonded to R¹³, and R¹³ optionally is bonded to R¹¹, in each case to independently form a five-, six-, or seven-membered carbocyclic or heterocyclic ring, the heterocyclic ring comprising at least one atom from the group consisting of N, P, O and S;
   each of R⁶, R⁷, R¹¹, and R¹² is independently (i) hydrogen, (ii) C₁-C₄₀ hydrocarbyl (such as C₁-C₂₂ alkyl, C₂-C₂₂ alkenyl, C₆-C₂₂ aryl), (iii) a heteroatom or a heteroatom-containing group (such as —OR¹⁶, —NR¹⁷₂, halogen, or five-, six-, or seven-membered heterocyclic ring including at least one atom selected from the group consisting of N, P, O and S; or such as A(R¹⁹)(R²⁰)(R²¹ where A is Si or Ge); wherein R⁶, R⁷, R¹¹, and R¹² are optionally substituted with halogen, —OR¹⁶, or —NR¹⁷₂, wherein R⁶ optionally is bonded to R⁸, R¹¹ optionally is bonded to R¹³, or R¹⁵ optionally is bonded to R¹² in each case to independently form a five-, six-, or seven-membered carbocyclic or heterocyclic ring, the heterocyclic ring comprising at least one atom from the group consisting of N, P, O and S;
   each of R¹⁶ and R¹⁷ is independently hydrogen, oxygen, C₁-C₂₂ alkyl, C₂-C₂₂ alkenyl, or C₆-C₂₂ aryl, wherein each R¹⁶ and R¹⁷ is independently optionally substituted with halogen, or two R¹⁶ radicals optionally bond to form a five- or six-membered ring, or two R¹⁷ radicals optionally bond to form a five- or six-membered carbocyclic or heterocyclic ring, the heterocyclic ring comprising at least one atom from the group consisting of N, P, O and S;
   at least one of R¹, R², R³, R⁴, R⁵, R⁶, R⁷, R⁸, R⁹, R¹⁰, R¹¹, R¹², R¹³, R¹⁴, and R¹⁵ is —(R¹⁸)_{q}A(R¹⁹)(R²⁰)(R²¹), wherein: A is Si or Ge; R¹⁸ is C₁-C₁₀ hydrocarbyl; each of R¹⁹, R²⁰, and R²¹ is independently C₁-C₄₀ hydrocarbyl, and q is 0 or 1; wherein R¹⁹ optionally is bonded to R²⁰, R²⁰ optionally is bonded to R²¹, and R¹⁹ optionally is bonded to R²¹, in each case to independently form a five-, six-, or seven-membered carbocyclic or heterocyclic ring, the heterocyclic ring comprising at least one atom from the group consisting of N, P, O and S;
   each of E¹, E², and E³ is independently carbon, nitrogen or phosphorus;
   u¹ is 0 if E¹ is nitrogen or phosphorus, u² is 0 if E² is nitrogen or phosphorus, u³ is 0 if E³ nitrogen or phosphorus, u¹ is 1 if Et is carbon, u² is 1 if E² is carbon, and u³ is 1 if E³ is carbon,
   each of X¹ and X² is independently an anionic ligand, wherein X¹ optionally is bonded to X² to form a five-, six-, or seven-membered carbocyclic or heterocyclic ring, the heterocyclic ring comprising at least one atom from the group consisting of N, P, O and S;
   r is 1 or 2;
   s is 0 to 2;
   D is a neutral donor;
   t is 0 to 2; and
   the sum of r, s, and t is 3 or less.

In some embodiments, M is a Group 8 metal selected from Fe, Ru, and Os. In some embodiments, M is Fe.

Referencing the —(R¹⁸)_{q}A(R¹⁹)(R²⁰)(R²¹) moiety, A could for example be Si. R¹⁸ could preferably be an unsubstituted hydrocarbyl, and for example could be selected from methylene, ethylene, propylene, butylene, pentylene, phenyl, and benzyl (and, in these and other embodiments, q would be 1). Optionally, R¹⁹, R²⁰, and R²¹ together can have at least ten carbon atoms, such as 10 carbon atoms to 50 carbon atoms, such as 10 carbon atoms to 25 carbon atoms, alternatively 15 carbon atoms to 30 carbon atoms. Each of R¹⁹, R²⁰, and R²¹ can be independently C₁-C₄₀ hydrocarbyl, such as C₄-C₄₀ hydrocarbyl, such as C₄-C₄₀ alkyl, such as butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, or isomers thereof. Optionally, each of R¹⁹, R²⁰, and R²¹ is independently C₁-C₄₀ unsubstituted hydrocarbyl (i.e. does not contain a heteroatom or hetero-atom containing group). For instance, at least one of R¹⁹, R²⁰, and R²¹ is C₄-C₃₀ alkyl, such as C₈ to C₂₀ alkyl. As another possibility, at least two of R¹⁹, R²⁰, and R²¹ are C₄-C₃₀ alkyl, such as C₆ to C₂₀ alkyl. As another example, two of R¹⁹, R²⁰, and R²¹ are a C₁-C₁₀ alkyl and the remaining is one of R¹⁹, R²⁰, and R²¹ is C₅-C₄₀ alkyl, such as C₁₀-C₂₀ alkyl. Or, all of R¹⁹, R²⁰, and R²¹ can be C₄-C₃₀ alkyl, such as C₆ to C₂₀ alkyl.

In some embodiments, —(R¹⁸)_{q}A(R¹⁹)(R²⁰)(R²¹) can be any suitable silane, such as (trialkylsilyl)C₁-C₂₀ alkyl-, such as (trialkylsilyl)C₁-C₁₀ alkyl-, such as (trialkylsilyl)C₁-C₅ alkyl-. In at least one embodiment, —(R¹⁸)_{q}A(R¹⁹)(R²⁰)(R²¹) is independently selected from (tributylsilyl)methyl-, (tripentylsilyl)methyl-, (trihexylsilyl)methyl-, (triheptylsilyl)methyl-, (trioctylsilyl)methyl-, (trinonylsilyl)methyl-, (decyl)₃(silyl)methyl-, (dimethyl)(n-decyl)silylmethyl-, (diethyl)(n-decyl)silylmethyl-, (dimethyl)(n-undecyl)silylmethyl-, (diethyl)(n-undecyl)silylmethyl-, (dimethyl)(n-dodecyl)silylmethyl-, (diethyl)(n-dodecyl)silylmethyl-, (dimethyl)(n-tridecyl)silylmethyl-, (diethyl)(n-tridecyl)silylmethyl-, (dimethyl)(n-tetradecyl)silylmethyl-, (diethyl)(n-tetradecyl)silylmethyl-, (dimethyl)(n-pentadecyl)silylmethyl-, (diethyl)(n-pentadecyl)silylmethyl-, (dimethyl)(n-hexadecyl)silylmethyl-, (diethyl)(n-hexadecyl)silylmethyl-, (dimethyl)(n-heptadecyl)silylmethyl-, (diethyl)(n-heptadecyl)silylmethyl-, (dimethyl)(n-octadecyl)silylmethyl-, (diethyl)(n-octadecyl)silylmethyl-, (dimethyl)(n-nonadecyl)silylmethyl-, (diethyl)(n-nonadecyl)silylmethyl-, (dimethyl)(icosyl)silylmethyl-, (diethyl)(icosyl)silylmethyl-, or isomers thereof. In some embodiments, —(R¹⁸)_{q}A(R¹⁹)(R²⁰)(R²¹) is (tributylsilyl)methyl or (trihexylsilyl)methyl.

In some embodiments, each of X¹ and X² is independently selected from hydrocarbyl radicals having from 1 to 20 carbon atoms, halides, hydrides, amides, alkoxides, sulfides, phosphides, dienes, amines, phosphines, ethers, or a combination thereof. In some embodiments, each X is a C₁-C₅ alkyl group, such as each of X¹ and X² is a methyl group. In some embodiments, each of X¹ and X² is independently methyl, ethyl, propyl, butyl, pentyl, hexyl, heptyl, octyl, nonyl, decyl, undecyl, or dodecyl. In some embodiments, each of X¹ and X² is a halide. For example, each of X¹ and X² can be independently chloro or bromo.

In some embodiments, r is 1. In some embodiments, s is 1. In at least one embodiment, r and s are the same.

In at least one embodiment, each of R¹ and R² is independently C₁-C₂₂ alkyl or C₆-C₂₂ aryl wherein each of R¹ and R² is optionally substituted with halogen. One or more of R¹ and R² may be independently selected from methyl, ethyl, propyl, butyl, pentyl, hexyl, heptyl, octyl, nonyl, decyl, undecyl, dodecyl, phenyl, substituted phenyl, biphenyl or an isomer thereof, which may be halogenated (such as perfluoropropyl, perfluorobutyl, perfluoroethyl, perfluoromethyl), substituted hydrocarbyl radicals and all isomers of substituted hydrocarbyl radicals including phenyl, or all isomers of hydrocarbyl substituted phenyl including methylphenyl, dimethylphenyl, trimethylphenyl, tetramethylphenyl, pentamethylphenyl, diethylphenyl, triethylphenyl, propylphenyl, dipropylphenyl, tripropylphenyl, dimethylethylphenyl, dimethylpropylphenyl, dimethylbutylphenyl, or dipropylmethylphenyl. In at least one embodiment, one or more of R¹ and R² are methyl. In some embodiments, one or more of R¹ or R² is —(R¹⁸)_{q}A(R¹⁹)(R²⁰)(R²¹) described above.

In at least one embodiment, t is 0, in which case D is absent. In an alternate embodiment, D is a neutral donor such as a neutral Lewis base, such as, for example, amines, alcohols, ethers, ketones, aldehydes, esters, sulfides or phosphines, which can be bonded with the metal center or can still be contained in the complex as residual solvent from the preparation of the metal complexes.

In at least one embodiment, the catalyst compound represented by Formula (I) has an electron donating side. At least one of R⁶ or R⁷ is independently halogen, —CF₃, —OR¹⁶, or —NR¹⁷₂. For example, at least one of R⁶ or R⁷ can independently be selected from fluorine, chlorine, bromine, or iodine. R⁸, R⁹, and R¹⁰ can be independently hydrogen, C₁-C₂₂ alkyl, C₂-C₂₂ alkenyl, C₆-C₂₂ aryl, —OR¹⁶, —NR¹⁷₂ halogen, or five-, six-, or seven-membered heterocyclic ring including at least one atom selected from the group consisting of N, P, O and S; wherein R⁸, R⁹, and R¹⁰ are optionally substituted with halogen, —OR¹⁶, or —NR¹⁷₂.

In some embodiments, each of R¹⁶ and R¹⁷ is independently hydrogen, C₁-C₂₂ alkyl, C₂-C₂₂ alkenyl, or C₆-C₂₂ aryl, wherein R¹⁶ and or R¹⁷ is optionally substituted with halogen, or two R¹⁶ and R¹⁷ radicals optionally bond to form a five- or six-membered ring.

In some embodiments, at least one of R⁶, R⁷, R¹¹, and R¹² is independently a heteroatom or a heteroatom-containing group, or at least one of the R⁶, R⁷, R¹¹, and R¹² is not methyl, or if R¹¹ is H and R¹² is iPr, then at least one of R⁶ and R⁷ is not methyl. In at least one embodiment, at least one of R⁶, R⁷, R¹¹, or R¹² is independently halogen, —CF₃, —OR¹⁶, or —NR¹⁷₂, such as at least one of the R⁶, R⁷, R¹¹, or R¹² is halogen, or at least one of R⁶, R⁷, R¹¹, or R¹² is methyl, ethyl, propyl, butyl, pentyl, or hexyl. For example, at least one of R⁶, R⁷, R¹, or R¹² is independently selected from fluorine, chlorine, bromine, or iodine. In at least one embodiment, R⁶, R⁷, R¹¹, and R¹² are independently selected from methyl, ethyl, tert-butyl, F, Br, Cl, and I.

In at least one embodiment, the catalyst compound represented by Formula (I) has an electron withdrawing side. Each of R¹¹, R¹², R¹³, R¹⁴, and R¹⁵ can be independently hydrogen, C₁-C₂₂ alkyl, C₂-C₂₂ alkenyl, C₆-C₂ aryl, —OR¹⁶, —NR¹⁷₂, halogen, —NO₂, or five-, six-, or seven-membered heterocyclic ring including at least one atom selected from N, P, O, and S. R¹¹, R¹², R¹³, R¹⁴, and R¹⁵ can be independently substituted with —NO₂, —CF₃, —CF₂CF₃, —CH₂CF₃, halogen, —OR¹⁶, or —NR¹⁷₂. Furthermore, each of R¹¹, R¹², R¹³, R¹⁴, and R¹⁵ can be independently hydrogen, C₁-C₂₂ alkyl, C₂-C₂₂-alkenyl, C₆-C₂₂-aryl, where at least one of R¹¹, R¹², R¹³, R¹, and R¹⁵ can be substituted with —NO₂, —CF₃, —CF₂CF₃, —CH₂CF₃, halogen, —OR¹⁶, or —NR¹⁷₂. In at least one embodiment, at least one of R¹¹, R¹², R¹³, R¹⁴, and R¹⁵ is halogen or C₁-C₂₂ alkyl substituted with one or more halogen atoms. In at least one embodiment, each of R¹¹, R¹², R¹³, R¹⁴, and R¹⁵ is independently hydrogen, halogen (such as fluorine, chlorine, bromine, or iodine), or trihalomethyl (such as trichloromethyl or trifluoromethyl), where at least one of R¹¹, R¹², R¹³, R¹⁴, and R¹⁵ is halogen or trihalomethyl.

Each of R⁶, R⁷, R⁸, R⁹, R¹⁰, R¹¹, R¹², R¹³, R¹⁴, and R¹⁵ can be independently selected from hydrogen, methyl, ethyl, propyl, butyl, pentyl, hexyl, heptyl, octyl, nonyl, decyl, undecyl, dodecyl, phenyl, substituted phenyl, biphenyl or an isomer thereof, which may be halogenated (such as perfluoropropyl, perfluorobutyl, perfluoroethyl, perfluoromethyl), phenyl, methylphenyl, dimethylphenyl, trimethylphenyl, tetramethylphenyl, pentamethylphenyl, diethylphenyl, triethylphenyl, propylphenyl, dipropylphenyl, tripropylphenyl, dimethylethylphenyl, dimethylpropylphenyl, dimethylbutylphenyl, or dipropylmethylphenyl, or isomers thereof. In some embodiments, one or more of R⁶, R⁷, R⁸, R⁹, R¹⁰, R¹¹, R¹², R¹³, R¹⁴, or R¹⁵ is
(R¹⁸)_{q}A(R¹⁹)(R²⁰)(R²¹) described above.

In at least one embodiment, each of E¹, E², and E³ is independently carbon, nitrogen or phosphorus, such as each of u¹, u², or u³ is independently 0 if E¹, E², or E³ is nitrogen or phosphorus, and each of u¹, u², or u³ is independently 1 if E¹, E², or E³ is carbon. Each of R³, R⁴, and R⁵ can be independently hydrogen or C₁-C₂2 alkyl. In at least one embodiment, E¹, E², and E³ are carbon, and each of R³, R⁴, and R⁵ is hydrogen. In at least one embodiment, each of R³, R⁴, and R⁵ is independently selected from hydrogen, methyl, ethyl, propyl, butyl, pentyl, hexyl, heptyl, octyl, nonyl, decyl, dimethyl-pentyl, tert-butyl, isopropyl, or isomers thereof, such as R³, R⁴, and R⁵ are hydrogen. In some embodiments, one or more of R³, R⁴, or R⁵ is —(R⁸)_{q}A(R¹⁹)(R²⁰)(R²¹) described above.

In at least one embodiment, the catalyst compound represented by Formula (I) is one or more of:

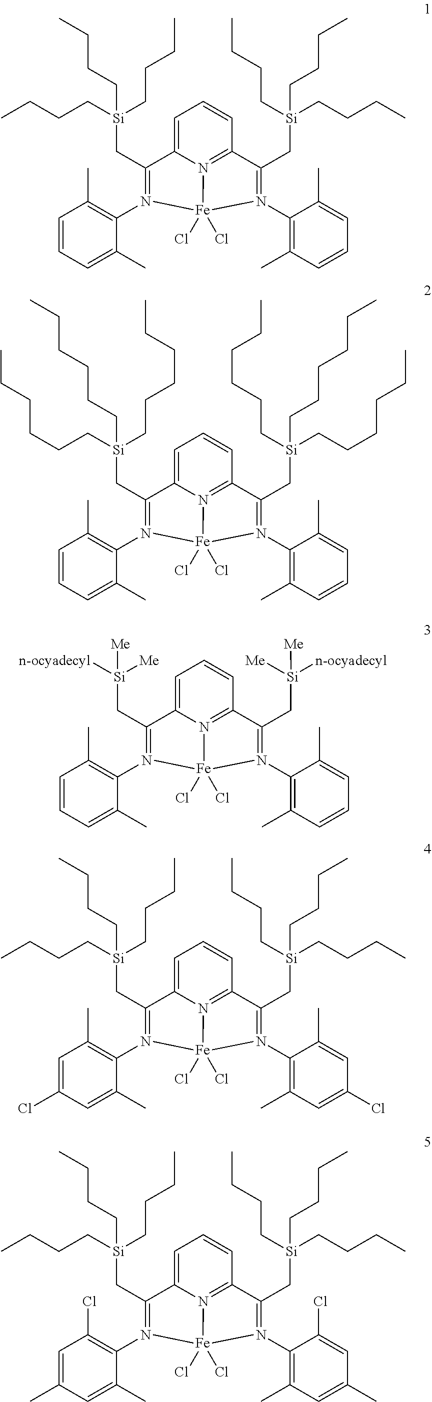

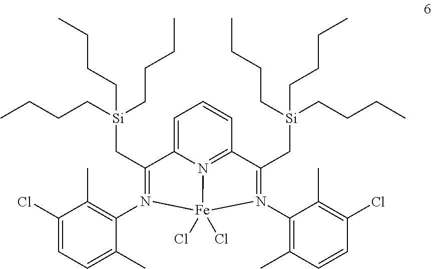

In at least one embodiment, two or more different catalyst compounds are present in a catalyst system. In at least one embodiment, two or more different catalyst compounds are present in the reaction zone of a reactor where the polymerization process(es) of the present disclosure occur. When two catalyst compounds are used in one reactor as a mixed catalyst system, the two catalyst compounds can be chosen such that the two are compatible. A simple screening method such as by ¹H or ¹³C NMR, known to those of ordinary skill in the art, can be used to determine which catalyst compounds are compatible. The same activator can be used for both catalyst compounds, however, two different activators, such as a non-coordinating anion activator and an alumoxane, can be used in combination. If one or more catalyst compounds contain an X¹ or X² ligand which is not a hydride, hydrocarbyl, or substituted hydrocarbyl, then the alumoxane may be contacted with the catalyst compound(s) prior to addition of the non-coordinating anion activator.

The two catalyst compounds may be used in any suitable ratio. Molar ratios of (A) transition metal compound to (B) transition metal compound can be (A:B) of 1:1000 to 1000:1, alternatively 1:100 to 500:1, alternatively 1:10 to 200:1, alternatively 1:1 to 100:1, alternatively 1:1 to 75:1, and alternatively 5:1 to 50:1. The suitable ratio chosen will depend on the exact catalyst compounds chosen, the method of activation, and the end product desired. In at least one embodiment, when using the two catalyst compounds, where both are activated with the same activator, mole percentages, based upon the molecular weight of the catalyst compounds, can be about 10% to about 99.9% A to about 0.1% to about 90% B, alternatively about 25% to about 99% A to about 0.5% to about 75% B, alternatively about 50% to about 99% A to about 1% to about 50% B, and alternatively about 75% to about 99% A to about 1% to about 10% B.

### Methods to Prepare the Catalyst Compounds.

The following is a generic description to prepare a catalyst compound of the present disclosure and further exemplified in the examples. All air sensitive syntheses can be carried out in nitrogen purged dry boxes. Solvents can be available from commercial sources. Starting materials (reactants, etc.) may be available from commercial sources.

### General Procedure I: Imine Condensation

A diacetylpyridine, an aniline, a catalyst support and dried molecular sieves can be combined in any suitable solvent (e.g., toluene) to form a reaction mixture. The reaction mixture can be stirred with heat for any suitable amount of time. The reaction mixture can then be filtered through a silica pad that is then washed with any suitable solvent (e.g., dichloromethane). The filtrate can be concentrated and recrystallized using any suitable solvent (e.g., ethanol) and filtered.

### General Procedure II: Silylation

The product of General Procedure I (imine product) can be treated with any suitable non-nucleophilic strong base (such as lithium diisopropylamide) at sub-ambient temperature for any suitable period of time using any suitable solvent (e.g., tetrahydrofuran). A silyl chloride can then be added to the reaction mixture, which can be stirred at ambient temperature for any suitable period of time. The reaction mixture can then be quenched (e.g., with water) and diluted with any suitable solvent (e.g., hexane). The aqueous phase formed from quenching can be extracted with any suitable solvent (e.g., dichloromethane). The solvent phase from the extraction can be dried using any suitable drying agent (e.g., MgSO₄) and then concentrated. The concentrate can be recrystallized using any suitable solvent (e.g., ethanol) and filtered and washed.

### General Procedure III: Metallation

The product of General Procedure II (silyl ligand) can be treated with a metal chloride (such as iron dichloride, iron dibromide, iron trichloride, or iron tribromide) at ambient temperature for any suitable period of time. The reaction mixture can be concentrated to form the metal-containing compound product.

### Activators

The terms “cocatalyst” and “activator” are used herein interchangeably.

The catalyst systems described herein may comprise a catalyst complex as described above and an activator such as alumoxane or a non-coordinating anion and may be formed by combining the catalyst components described herein with activators in any manner known from the literature including combining them with supports, such as silica. The catalyst systems may also be added to or generated in solution polymerization or bulk polymerization (in the monomer). Catalyst systems of the present disclosure may have one or more activators and one, two or more catalyst components. Activators are defined to be any compound which can activate any one of the catalyst compounds described above by converting the neutral metal compound to a catalytically active metal compound cation. Non-limiting activators, for example, may include alumoxanes, aluminum alkyls, ionizing activators, which may be neutral or ionic, and conventional-type cocatalysts. Suitable activators may include alumoxane compounds, modified alumoxane compounds, and ionizing anion precursor compounds that abstract a reactive, G-bound, metal ligand making the metal compound cationic and providing a charge-balancing non-coordinating or weakly coordinating anion, e.g., a non-coordinating anion.

In at least one embodiment, the catalyst system includes an activator and the catalyst compound of Formula (I).

### Alumoxane Activators

Alumoxane activators are utilized as activators in the catalyst systems described herein. Alumoxanes are generally oligomeric compounds containing —Al(Ra′″)—O— sub-units, where R^{a′″} is an alkyl group. Examples of alumoxanes include methylalumoxane (MAO), modified methylalumoxane (MMAO), ethylalumoxane and isobutylalumoxane. Alkylalumoxanes and modified alkylalumoxanes are suitable as catalyst activators, such as when the abstractable ligand is an alkyl, halide, alkoxide or amide. Mixtures of different alumoxanes and modified alumoxanes may also be used. It may be suitable to use a visually clear methylalumoxane. A cloudy or gelled alumoxane can be filtered to produce a clear solution or clear alumoxane can be decanted from the cloudy solution. A useful alumoxane is a modified methyl alumoxane (MMAO) cocatalyst type 3A (commercially available from Akzo Chemicals, Inc. under the trade name Modified Methylalumoxane type 3A, covered under patent number U.S. Pat. No. 5,041,584, which is incorporated by reference herein). Another useful alumoxane is solid polymethylaluminoxane as described in U.S. Pat. Nos. 9,340,630, 8,404,880, and 8,975,209, which are incorporated by reference herein.

When the activator is an alumoxane (modified or unmodified), in at least one embodiment, select the maximum amount of activator at up to a 5,000-fold molar excess Al/M over the catalyst compound (per metal catalytic site). The minimum activator-to-catalyst-compound can be a 1:1 molar ratio. Alternate ranges may include about 1:1 to about 500:1, alternately about 1:1 to about 200:1, alternately about 1:1 to about 100:1, or alternately about 1:1 to about 50:1.

In an alternate embodiment, little or no alumoxane is used in the polymerization processes described herein. For example, alumoxane can be present at zero mol %, alternately the alumoxane can be present at a molar ratio of aluminum to catalyst compound transition metal less than 500:1, such as less than 300:1, such as less than 100:1, such as less than 1:1.

### Ionizing/Non-Coordinating Anion Activators

The term “non-coordinating anion” (NCA) means an anion which either does not coordinate to a cation or which is only weakly coordinated to a cation thereby remaining sufficiently labile to be displaced by a Lewis base. “Compatible” non-coordinating anions are those which are not degraded to neutrality when the initially formed complex decomposes. Further, the anion will not transfer an anionic substituent or fragment to the cation so as to cause it to form a neutral transition metal compound and a neutral by-product from the anion. Non-coordinating anions useful in accordance with the present disclosure are those that are compatible, stabilize the transition metal cation in the sense of balancing its ionic charge at +1, and yet retain sufficient lability to permit displacement during polymerization. Suitable ionizing activators may include an NCA, such as a compatible NCA.

It is within the scope of the present disclosure to use an ionizing activator, neutral or ionic. It is also within the scope of the present disclosure to use neutral or ionic activators alone or in combination with alumoxane or modified alumoxane activators.

For descriptions of suitable activators please see U.S. Pat. Nos. 8,658,556 and 6,211,105, incorporated by reference herein.

Additional suitable activators are described in US Patent Publication 2021/0179650, incorporated by reference herein.

In some embodiments, an activator can be one or more of N,N-dimethylanilinium tetrakis(perfluorophenyl)borate, N,N-dimethylanilinium tetrakis(perfluoronaphthyl)borate, dioctadecylmethylammonium tetrakis(perfluorophenyl)borate, N,N-dimethylanilinium tetrakis(perfluorobiphenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, or triphenylcarbenium tetra(perfluorophenyl)borate.

In a at least one embodiment, the activator is selected from one or more of a triaryl carbenium (such as triphenylcarbenium tetraphenylborate, triphenylcarbenium tetrakis(pentafluorophenyl)borate, triphenylcarbenium tetrakis-(2,3,4,6-tetrafluorophenyl)borate, triphenylcarbenium tetrakis(perfluoronaphthyl)borate, triphenylcarbenium tetrakis(perfluorobiphenyl)borate, or triphenylcarbenium tetrakis(3,5-bis(trifluoromethyl)phenyl)borate).

Suitable activator-to-catalyst ratio, e.g., all NCA activators-to-catalyst ratio may be about a 1:1 molar ratio. Alternate ranges include about 0.1:1 to about 100:1, alternately about 0.5:1 to about 200:1, alternately about 1:1 to about 500:1, alternately about 1:1 to about 1000:1. Suitable ranges can be about 0.5:1 to about 10:1, such as about 1:1 to about 5:1.

It is also within the scope of the present disclosure that the catalyst compounds can be combined with combinations of alumoxanes and NCA's (see for example, U.S. Pat. Nos. 5,153,157; 5,453,410; EP 0 573 120 Bi; WO1994/007928; and WO1995/014044 which discuss the use of an alumoxane in combination with an ionizing activator).

Chain transfer agents may be used in polymerization processes of the present disclosure. Useful chain transfer agents can be hydrogen, alkylalumoxanes, a compound represented by the formula AlR₃, ZnR₂ (where each R is, independently, a C₁-C₈ aliphatic radical, such as methyl, ethyl, propyl, butyl, pentyl, hexyl octyl or an isomer thereof) or a combination thereof, such as diethyl zinc, methylalumoxane, trimethylaluminum, triisobutylaluminum, trioctylaluminum, or a combination thereof.

Furthermore, a catalyst system of the present disclosure may include a metal hydrocarbenyl chain transfer agent represented by the formula:

Al(R′)₃₋ᵥ(R″)ᵥ

where each R′ can be independently a C₁-C₃₀ hydrocarbyl group, and or each R″, can be independently a C₄-C₂₀ hydrocarbenyl group having an end-vinyl group; and v can be from 0.1 to 3.

### Alkane-Soluble Activators

Activators of the present disclosure may be those designed to have improved solubility in alkane solvents, such as the activators described in US Pub. No. 2019/0330139, WO2021/025903, US Pub. No. 2021/0122844, US Pub. No. 2021/0121863, and US Pub. No. 2021/0179537, incorporated herein by reference.

For example, activators, such as ammonium or phosphonium metallate or metalloid activator compounds, can include (1) ammonium or phosphonium groups and long-chain aliphatic hydrocarbyl groups and (2) metallate or metalloid anions, such as borates or aluminates.

In some embodiments, an activator compound is represented by Formula (AT):

[R¹R²R³EH]_{d}⁺[M^{k}+Qₙ]^{d-} (AI)
wherein:
   E is nitrogen or phosphorus, such as nitrogen;
   d is 1, 2 or 3(such as 3); k is 1, 2, or 3(such as 3); n is 1, 2, 3, 4, 5, or 6 (such as 4, 5, or 6); n−k=d (such as d is 1, 2 or 3; k is 3; n is 4, 5, or 6, such as when M is B, n is 4);
   each of R¹, R², and R³ is independently H, optionally substituted C₁-C₄₀ alkyl (such as branched or linear alkyl), or optionally substituted C₅-C₅₀-aryl (alternately each of R¹, R², and R³ is independently unsubstituted or substituted with at least one of halide, C₅-C₅₀ aryl, C₆-C₃₅ arylalkyl, C₆-C₃₅ alkylaryl and, in the case of the C₅-C₅₀-aryl, C₁-C₅₀ alkyl); wherein R¹, R², and R³ together comprise 15 or more carbon atoms,
   M is an element selected from group 13 of the Periodic Table of the Elements, such as B or Al, such as B; and
   each Q is independently selected from the group consisting of a hydrogen, bridged or unbridged dialkylamido, halide, alkoxy, substituted alkoxy, aryloxy, substituted aryloxy, hydrocarbyl, substituted hydrocarbyl, halocarbyl, substituted halocarbyl, and halosubstituted-hydrocarbyl radical, such as a fluorinated aryl group, such fluoro-phenyl or fluoro-naphthyl, such as perfluorophenyl or perfluoronaphthyl.

In some embodiments of activator compounds represented by Formula (AI), at least one of R¹, R², and R³ is a linear or branched C₃-C₄₀ alkyl group (alternately such as a linear or branched C₇ to C₄₀ alkyl group).

The present disclosure also provides activator compounds represented by Formula (AI), described above where R¹ is a C₁-C₃₀ alkyl group (such as a C₁-C₁₀ alkyl group, such as C₁ to C₂ alkyl, such as methyl), wherein R¹ is optionally substituted, and each of R² and R³ is independently an optionally substituted branched or linear C₁-C₄₀ alkyl group or meta and/or para-substituted phenyl group, where the meta and para substituents are, independently, an optionally substituted C₁ to C₄₀ hydrocarbyl group, an optionally substituted alkoxy group, an optionally substituted silyl group, a halogen, or a halogen containing group, wherein R¹, R², and R³ together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 40 or more carbon atoms) and at least one of R¹, R², and R³ is a linear or branched alkyl (such as a C₃-C₄₀ branched alkyl, alternately C₇-C₄₀ branched alkyl).

The present disclosure further provides catalyst systems including activator compounds represented by Formula (AI), as described above where R¹ is methyl; and each of R² and R³ is independently C₁-C₄₀ branched or linear alkyl or C₅-C₅₀-aryl, wherein each of R¹, R², and R³ is independently unsubstituted or substituted with at least one of halide, C₅-C₅₀ aryl, C₆-C₃₅ arylalkyl, C₆-C₃₅ alkylaryl and, in the case of the C₅-C₅₀-aryl, C₁-C₅₀ alkyl; wherein R¹, R², and R³ together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 40 or more carbon atoms).

Activator compounds can include one or more of: N,N-di(hydrogenated tallow)methylammonium [tetrakis(perfluorophenyl)borate], N-methyl-4-nonadecyl-N-octadecylanilinium [tetrakis(perfluorophenyl)borate], N-methyl-4-hexadecyl-N-octadecylanilinium [tetrakis(perfluorophenyl)borate], N-methyl-4-tetradecyl-N-octadecylanilinium [tetrakis(perfluorophenyl)borate], N-methyl-4-dodecyl-N-octadecylanilinium [tetrakis(perfluorophenyl)borate], N-methyl-4-decyl-N-octadecylanilinium [tetrakis(perfluorophenyl)borate], N-methyl-4-octyl-N-octadecylanilinium [tetrakis(perfluorophenyl)borate], N-methyl-4-hexyl-N-octadecylanilinium [tetrakis(perfluorophenyl)borate], N-methyl-4-butyl-N-octadecylanilinium [tetrakis(perfluorophenyl)borate], N-methyl-4-octadecyl-N-decylanilinium [tetrakis(perfluorophenyl)borate], N-methyl-4-nonadecyl-N-dodecylanilinium [tetrakis(perfluorophenyl)borate], N-methyl-4-nonadecyl-N-tetradecylanilinium [tetrakis(perfluorophenyl)borate], N-methyl-4-nonadecyl-N-hexadecylanilinium [tetrakis(perfluorophenyl)borate], N-ethyl-4-nonadecyl-N-octadecylanilinium [tetrakis(perfluorophenyl)borate], N-methyl-N,N-dioctadecylammonium [tetrakis(perfluorophenyl)borate], N-methyl-N,N-dihexadecylammonium [tetrakis(perfluorophenyl)borate], N-methyl-N,N-ditetradecylammonium [tetrakis(perfluorophenyl)borate], N-methyl-N,N-didodecylammonium [tetrakis(perfluorophenyl)borate], N-methyl-N,N-didecylammonium [tetrakis(perfluorophenyl)borate], N-methyl-N,N-dioctylammonium [tetrakis(perfluorophenyl)borate], N-ethyl-N,N-dioctadecylammonium [tetrakis(perfluorophenyl)borate], N,N-di(octadecyl)tolylammonium [tetrakis(perfluorophenyl)borate], N,N-di(hexadecyl)tolylammonium [tetrakis(perfluorophenyl)borate], N,N-di(tetradecyl)tolylammonium [tetrakis(perfluorophenyl)borate], N,N-di(dodecyl)tolylammonium [tetrakis(perfluorophenyl)borate], N-octadecyl-N-hexadecyl-tolylammonium [tetrakis(perfluorophenyl)borate], N-octadecyl-N-hexadecyl-tolylammonium [tetrakis(perfluorophenyl)borate], N-octadecyl-N-tetradecyl-tolylammonium [tetrakis(perfluorophenyl)borate], N-octadecyl-N-dodecyl-tolylammonium [tetrakis(perfluorophenyl)borate], N-octadecyl-N-decyl-tolylammonium [tetrakis(perfluorophenyl)borate], N-hexadecyl-N-tetradecyl-tolylammonium [tetrakis(perfluorophenyl)borate], N-hexadecyl-N-dodecyl-tolylammonium [tetrakis(perfluorophenyl)borate], N-hexadecyl-N-decyl-tolylammonium [tetrakis(perfluorophenyl)borate], N-tetradecyl-N-dodecyl-tolylammonium [tetrakis(perfluorophenyl)borate], N-tetradecyl-N-decyl-tolylammonium [tetrakis(perfluorophenyl)borate], N-dodecyl-N-decyl-tolylammonium [tetrakis(perfluorophenyl)borate], N-methyl-N-octadecylanilinium [tetrakis(perfluorophenyl)borate], N-methyl-N-hexadecylanilinium [tetrakis(perfluorophenyl)borate], N-methyl-N-tetradecylanilinium [tetrakis(perfluorophenyl)borate], N-methyl-N-dodecylanilinium [tetrakis(perfluorophenyl)borate], N-methyl-N-decylanilinium [tetrakis(perfluorophenyl)borate], and N-methyl-N-octylanilinium [tetrakis(perfluorophenyl)borate].

### Optional Support Materials

In embodiments herein, the catalyst system may include an inert support material. The supported material can be a porous support material, for example, talc, and inorganic oxides. Other support materials include zeolites, clays, organoclays, or another organic or inorganic support material, or mixtures thereof.

The support material can be an inorganic oxide in a finely divided form. Suitable inorganic oxide materials for use in catalyst systems herein may include groups 2, 4, 13, and 14 metal oxides, such as silica, alumina, and mixtures thereof. Other inorganic oxides that may be employed either alone or in combination with the silica, or alumina can be magnesia, titania, zirconia. Other suitable support materials, however, can be employed, for example, finely divided functionalized polyolefins, such as finely divided polyethylene. Examples of suitable supports may include magnesia, titania, zirconia, montmorillonite, phyllosilicate, zeolites, talc, clays. Also, combinations of these support materials may be used, for example, silica-chromium, silica-alumina, silica-titania. In at least one embodiment, the support material is selected from Al₂O₃, ZrO₂, SiO₂, SiO₂/Al₂O₃, SiO₂/TiO₂, silica clay, silicon oxide/clay, or mixtures thereof.

The support material, such as an inorganic oxide, can have a surface area of about 10 m²/g to about 700 m²/g, pore volume of about 0.1 cm³/g to about 4.0 cm³/g and average particle size of about 5 m to about 500 μm. The surface area of the support material can be of about 50 m²/g to about 500 m²/g, pore volume of about 0.5 cm³/g to about 3.5 cm³/g and average particle size of about 10 m to about 200 m. For example, the surface area of the support material can be about 100 m²/g to about 400 m²/g, pore volume of about 0.8 cm³/g to about 3.0 cm³/g and average particle size can be about 5 m to about 100 m. The average pore size of the support material useful in the present disclosure can be of about 10 Å to about 1000 Å, such as about 50 Å to about 500 Å, and such as about 75 Å to about 350 Å. In at least one embodiment, the support material is a high surface area, amorphous silica (surface area=300 m²/gm; pore volume of 1.65 cm³/gm). For example, suitable silicas can be the silicas marketed under the tradenames of DAVISON™ 952 or DAVISON™ 955 by the Davison Chemical Division of W. R. Grace and Company. In other embodiments, DAVISON™ 948 is used. Alternatively, a silica can be ES-70™ silica (PQ Corporation, Malvern, Pennsylvania) that has been calcined, for example (such as at 875° C.).

The support material should be dry, that is, free of absorbed water. Drying of the support material can be effected by heating or calcining at about 100° C. to about 1000° C., such as at least about 600° C. When the support material is silica, it is heated to at least 200° C., such as about 200° C. to about 850° C., and such as at about 600° C.; and for a time of about 1 minute to about 100 hours, about 12 hours to about 72 hours, or about 24 hours to about 60 hours. The calcined support material must have at least some reactive hydroxyl (OH) groups to produce supported catalyst systems of the present disclosure. The calcined support material is then contacted with at least one polymerization catalyst including at least one catalyst compound and an activator.

The support material, having reactive surface groups, such as hydroxyl groups, is slurried in a non-polar solvent and the resulting slurry is contacted with a solution of a catalyst compound and an activator. In at least one embodiment, the slurry of the support material is first contacted with the activator for a period of time of about 0.5 hour to about 24 hours, about 2 hours to about 16 hours, or about 4 hours to about 8 hours. The solution of the catalyst compound is then contacted with the isolated support/activator. In at least one embodiment, the supported catalyst system is generated in situ. In alternate embodiments, the slurry of the support material is first contacted with the catalyst compound for a period of time of about 0.5 hour to about 24 hours, about 2 hours to about 16 hours, or about 4 hours to about 8 hours. The slurry of the supported catalyst compound is then contacted with the activator solution.

The mixture of the catalyst(s), activator(s) and support is heated about 0° C. to about 70° C., such as about 23° C. to about 60° C., such as at room temperature. Contact times can be about 0.5 hours to about 24 hours, such as about 2 hours to about 16 hours, or about 4 hours to about 8 hours.

Suitable non-polar solvents are materials in which all of the reactants used herein, e.g., the activator and the catalyst compound, are at least partially soluble and which are liquid at reaction temperatures. Non-polar solvents can be alkanes, such as isopentane, hexane, n-heptane, octane, nonane, and decane, although a variety of other materials including cycloalkanes, such as cyclohexane, aromatics, such as benzene, toluene, and ethylbenzene, may also be employed.

In at least one embodiment, the support material is a supported methylalumoxane (SMAO), which is an MAO activator treated with silica (e.g., ES-70-875 silica).

### Polymerization Processes

The present disclosure relates to polymerization processes where monomer (e.g., ethylene; propylene), and optionally comonomer, are contacted with a catalyst system including an activator and at least one catalyst compound, as described above. The catalyst compound and activator may be combined in any suitable order. The catalyst compound and activator may be combined prior to contacting with the monomer. Alternatively the catalyst compound and activator may be introduced into the polymerization reactor separately, wherein they subsequently react to form the active catalyst.

Monomers may include substituted or unsubstituted C₂ to C₄₀ alpha olefins, such as C₂ to C₂₀ alpha olefins, such as C₂ to C₁₂ alpha olefins, such as ethylene, propylene, butene, pentene, hexene, heptene, octene, nonene, decene, undecene, dodecene and isomers thereof. In at least one embodiment, the monomer includes ethylene and an optional comonomer including one or more C₃ to C₄₀ olefins, such as C₄ to C₂₀ olefins, such as C₆ to C₁₂ olefins. The C₃ to C₄₀ olefin monomers may be linear, branched, or cyclic. The C₃ to C₄₀ cyclic olefins may be strained or unstrained, monocyclic or polycyclic, and may optionally include heteroatoms and or one or more functional groups. In another embodiment, the monomer includes propylene and an optional comonomer including one or more ethylene or C₄ to C₄₀ olefins, such as C₄ to C₂₀ olefins, such as C₆ to C₁₂ olefins. The C₄ to C₄₀ olefin monomers may be linear, branched, or cyclic. The C₄ to C₄₀ cyclic olefins may be strained or unstrained, monocyclic or polycyclic, and may optionally include heteroatoms and or one or more functional groups.

Exemplary C₂ to C₄₀ olefin monomers and optional comonomers may include ethylene, propylene, butene, pentene, hexene, heptene, octene, nonene, decene, undecene, dodecene, norbornene, ethylidenenorbornene, vinylnorbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof, such as hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbornene, norbornadiene, and their respective homologs and derivatives, such as norbornene, norbornadiene, and dicyclopentadiene.

Polymerization processes of the present disclosure can be carried out in any suitable manner. Any suitable suspension, homogeneous, bulk, solution, slurry, or gas phase polymerization process can be used. Such processes can be run in a batch, semi-batch, or continuous mode. Homogeneous polymerization processes and slurry processes can be used. A bulk homogeneous process can be used. Alternately, no solvent or diluent is present or added in the reaction medium, (except for the small amounts used as the carrier for the catalyst system or other additives, or amounts found with the monomer; e.g., propane in propylene). In another embodiment, the process is a slurry process. As used herein, the term “slurry polymerization process” means a polymerization process where a supported catalyst is employed and monomers are polymerized on the supported catalyst particles. At least 95 wt % of polymer products derived from the supported catalyst are in granular form as solid particles (not dissolved in the diluent).

Suitable diluents/solvents for polymerization may include non-coordinating, inert liquids. Examples of diluents/solvents for polymerization may include straight and branched-chain hydrocarbons, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (e.g., Isopar™); perhalogenated hydrocarbons, such as perfluorinated C₄ to C₁₀ alkanes, chlorobenzene, and aromatic and alkylsubstituted aromatic compounds, such as benzene, toluene, mesitylene, and xylene. Suitable solvents may also include liquid olefins which may act as monomers or comonomers including ethylene, propylene, 1-butene, 1-hexene, 1-pentene, 3-methyl-1-pentene, 4-methyl-1-pentene, 1-octene, 1-decene, and mixtures thereof. In at least one embodiment, aliphatic hydrocarbon solvents are used as the solvent, such as isobutane, butane, pentane, isopentane, hexanes, isohexane, heptane, octane, dodecane, and mixtures thereof, cyclic and alicyclic hydrocarbons, such as cyclohexane, cycloheptane, methylcyclohexane, methylcycloheptane, and mixtures thereof. In another embodiment, the solvent is not aromatic, such as aromatics are present in the solvent at less than 1 wt %, such as less than 0.5 wt %, such as less than 0 wt % based upon the weight of the solvents.

In at least one embodiment, the feed concentration of the monomers and comonomers for the polymerization is 60 vol % solvent or less, such as 40 vol % or less, such as 20 vol % or less, based on the total volume of the feedstream. In at least one embodiment, the polymerization is run in a bulk process.

Polymerizations can be run at any temperature and or pressure suitable to obtain the desired polymers. Suitable temperatures and or pressures include a temperature of about 0° C. to about 300° C., such as about 20° C. to about 200° C., such as about 35° C. to about 160° C., such as about 80° C. to about 160° C., such as about 85° C. to about 140° C. Polymerizations can be run at a pressure of about 0.1 MPa to about 25 MPa, such as about 0.45 MPa to about 6 MPa, or about 0.5 MPa to about 4 MPa.

In a suitable polymerization, the run time of the reaction can be up to about 300 minutes, such as about 5 minutes to about 250 minutes, such as about 10 minutes to about 120 minutes, such as about 20 minutes to about 90 minutes, such as about 30 minutes to about 60 minutes. In a continuous process the run time may be the average residence time of the reactor. In at least one embodiment, the run time of the reaction is up to about 45 minutes. In a continuous process the run time may be the average residence time of the reactor.

In at least one embodiment, hydrogen is present in the polymerization reactor at a partial pressure of about 0.001 psig to about 50 psig (0.007 kPa to 345 kPa), such as about 0.01 psig to about 25 psig (0.07 kPa to 172 kPa), such as about 0.1 psig to about 10 psig (0.7 kPa to 70 kPa).

In at least one embodiment, the hydrogen content is about 0.0001 ppm to about 2,000 ppm, such as about 0.0001 ppm to about 1,500 ppm, such as about 0.0001 ppm to about 1,000 ppm, such as about 0.0001 ppm to about 500 ppm. Alternately, hydrogen can be present at zero ppm.

In at least one embodiment, little or no alumoxane is used in the process to produce the polymers. For example, alumoxane can be present at zero mol %, alternately the alumoxane can be present at a molar ratio of aluminum to transition metal less than 500:1, such as less than 300:1, such as less than 100:1, such as less than 1:1.

Unless otherwise indicated, “catalyst productivity” is a measure of how many grams of polymer (P) are produced using a polymerization catalyst comprising W g of catalyst (cat), over a period of time of T hours; and may be expressed by the following formula: P/(T×W) and expressed in units of gPgcat⁻¹ hr⁻¹. Unless otherwise indicated, “catalyst activity” is a measure of how active the catalyst is and is reported as the mass of product polymer (P) produced per mole of catalyst (cat) used (kgP/molcat) or as the mass of product polymer (P) produced per mass of catalyst (cat) used (gP/gcat).

In at least one embodiment, according to the present disclosure, a catalyst system has a catalyst activity of greater than about 500 gP/gCat, such as greater than about 800 gP/gCat, such as about 700 gP/gCat to about 1,500 gP/gCat, such as about 900 gP/gCat to about 1,100 gP/gCat.

In at least one embodiment, according to the present disclosure, a catalyst system has a catalyst productivity of greater than about 100 gP/gCat/hr, such as greater than about 375 gP/gCat/hr, such as about 300 gP/gCat/hr to about 1,500 gP/gCat/hr, such as about 900 gP/gCat/hr to about 1,100 gP/gCat/hr.

In at least one embodiment, the polymerization: 1) is conducted at temperatures of about 0° C. to about 300° C. (such as about 25° C. to about 250° C., such as about 50° C. to about 160° C., such as about 80° C. to about 140° C.); 2) is conducted at a pressure of atmospheric pressure to about 10 MPa (such as about 0.35 MPa to about 10 MPa, such as about 0.45 MPa to about 6 MPa, such as about 0.5 MPa to about 4 MPa); 3) is conducted in an aliphatic hydrocarbon solvent (such as isobutane, butane, pentane, isopentane, hexanes, isohexane, heptane, octane, dodecane, and mixtures thereof, cyclic and alicyclic hydrocarbons, such as cyclohexane, cycloheptane, methylcyclohexane, methylcycloheptane, and mixtures thereof; such as where aromatics are present in the solvent at less than 1 wt %, such as less than 0.5 wt %, such as at 0 wt % based upon the weight of the solvents); 4) wherein the catalyst system used in the polymerization comprises less than 0.5 mol %, such as about 0 mol % alumoxane, alternately the alumoxane is present at a molar ratio of aluminum to transition metal less than 500:1, such as less than 300:1, such as less than 100:1, such as less than 1:1; 5) the polymerization occurs in one reaction zone; 6) optionally scavengers (such as trialkyl aluminum compounds) are absent (e.g., present at zero mol %, alternately the scavenger is present at a molar ratio of scavenger metal to transition metal of less than 100:1, such as less than 50:1, such as less than 15:1, such as less than 10:1); and 7) optionally hydrogen is present in the polymerization reactor at a partial pressure of about 0.001 psig to about 50 psig (0.007 kPa to 345 kPa) (such as about 0.01 psig to about 25 psig (0.07 kPa to 172 kPa), such as about 0.1 psig to about 10 psig (0.7 kPa to 70 kPa)). In at least one embodiment, the catalyst system used in the polymerization includes no more than one catalyst compound. A “reaction zone” also referred to as a “polymerization zone” is a vessel where polymerization takes place, for example a stirred-tank reactor or a loop reactor. When multiple reactors are used in a continuous polymerization process, each reactor is considered as a separate polymerization zone. For a multi-stage polymerization in a batch polymerization process, each polymerization stage is considered as a separate polymerization zone. In at least one embodiment, the polymerization occurs in one reaction zone. Room temperature is 23° C. unless otherwise noted.

Other additives may also be used in the polymerization, as desired, such as one or more scavengers, hydrogen, aluminum alkyls, or chain transfer agents such as alkylalumoxanes, a compound represented by the formula AlR₃ or ZnR₂ (where each R is, independently, a C₁-C₈ aliphatic radical, such as methyl, ethyl, propyl, butyl, pentyl, hexyl octyl or an isomer thereof) or a combination thereof, such as diethyl zinc, methylalumoxane, trimethylaluminum, triisobutylaluminum, trioctylaluminum, or a combination thereof.

### Polymerizations Using Trim

Polymerizations processes of the present disclosure can be performed using a “trim” process.

For delivery of a catalyst slurry to a reactor, a high solids concentration of the slurry typically increases the slurry viscosity. A high solids concentration also increases the amount of foaming which is typically generated in a catalyst slurry vessel. A high slurry viscosity and foaming can cause handling problems, storage problems as well as reactor injection problems. Low viscosity diluents can be added to the slurry to reduce the viscosity. However, the reduced viscosity promotes settling of the slurry in the solution, which can result in plugging of reactor components and accumulation of solids on the walls of catalyst slurry vessels.

A second catalyst solution can be added (i.e. “trimmed”) to the slurry to adjust one or more properties “in-situ” of polymer being formed in a reactor. Such “trim” processes are very economical because they do not require a polymerization to cease in order to adjust polymer properties in the event a catalyst system is not behaving in a desirable way. However, a second catalyst is typically delivered to the slurry as a low viscosity solution, which can promote settling of the slurry solution and subsequent gelling and/or plugging of reactor components.

Accordingly, processes for polymerizing olefin(s) can include using dual catalyst systems. In particular, methods include combining a catalyst component slurry with a catalyst component solution (to “trim”) to form a third catalyst composition and introducing the third composition into a polymerization reactor.

In some embodiments, a method includes: contacting a first composition and a second composition in a line leading to the reactor to form a third composition. The first composition includes a first catalyst, a second catalyst, a support, and a diluent. The second composition includes a second catalyst and a second diluent. The method includes introducing the third composition from the line into a gas-phase fluidized bed reactor and exposing the third composition to polymerization conditions. The method includes obtaining a polyolefin.

Processes can include adjusting reactor conditions, such as an amount of second catalyst fed to the reactor, to control one or more polymer properties of the polyolefin obtained from the reactor.

Metal bis(imino) aryl catalyst compounds of the present disclosure can be the first catalyst or second catalyst used in a trim process. The first or second catalyst can be a different metal bis(imino) aryl catalyst or can be a catalyst that is not a metal bis(imino) aryl catalyst such as a metallocene, such as the metallocene EtInd (i.e., 1-EtIndenyl₂ZrMe₂) or HfP (i.e., (nPrCyclopentadienyl)₂HfMe₂. Other exemplary metallocene catalyst compounds are described in US Pub. No. 2022/0033536, incorporated by reference herein.

By using structures such as a metal bis(imino) aryl catalyst as the second catalyst trimmed on-line at various ratios onto slurry feeding the first catalyst, or vice versa, along with varying reactor conditions involving temperature, reaction mixture component concentrations, and the like, beneficial polyolefin products may be formed.

Additionally, it should also be contemplated that for the distinct catalysts selected, some of the second catalyst may be initially co-deposited with the first catalyst on a common support, and the remaining amount of the first catalyst or second catalyst added as trim.

The catalyst system may include a catalyst compound in a slurry and an added solution catalyst component that is added to the slurry. Generally, the first catalyst and/or second catalyst will be supported in the initial slurry, depending on solubility. However, in at least one embodiment, the initial catalyst component slurry may have no catalysts. In this case, two or more solution catalysts may be added as “trim” to the slurry to cause each to be supported.

The slurry may include one or more activators and supports, and one or more catalyst compounds. For example, the slurry may include two or more activators (such as alumoxane and a modified alumoxane) and a catalyst compound, or the slurry may include a supported activator and more than one catalyst compounds. In at least one embodiment, the slurry includes a support, an activator, and two catalyst compounds. In another embodiment the slurry includes a support, an activator and two different catalyst compounds, which may be added to the slurry separately or in combination. The slurry, containing silica and alumoxane, may be contacted with a catalyst compound, allowed to react, and thereafter the slurry is contacted with another catalyst compound, for example, as “trim.”

One or more diluents can be used to facilitate the combination of any two or more components of the catalyst system in the slurry or in the trim catalyst solution. For example, the single site catalyst compound and the activator can be combined together in the presence of toluene or another non-reactive hydrocarbon or hydrocarbon mixture to provide the catalyst mixture. In addition to toluene, other suitable diluents can include, but are not limited to, ethylbenzene, xylene, pentane, hexane, heptane, octane, other hydrocarbons, or any combination thereof. The support, either dry or mixed with toluene can then be added to the catalyst mixture or the catalyst/activator mixture can be added to the support.

The diluent can be or include mineral oil. Mineral oil can have a density of about 0.85 g/cm³ to about 0.9 g/cm³ at 25° C. according to ASTM D4052, such as about 0.86 g/cm³ to about 0.88 g/cm³. Mineral oil can have a kinematic viscosity at 25° C. of about 150 cSt to about 200 cSt according to ASTM D341, such as about 160 cSt to about 190 cSt, such as about 170 cSt. Mineral oil can have an average molecular weight of about 400 g/mol to about 600 g/mol according to ASTM D2502, such as about 450 g/mol to about 550 g/mol, such as about 500 g/mol. In at least one embodiment, a mineral oil is HYDROBRITE® 380 PO White Mineral Oil (“HB380”) from Sonneborn, LLC.

The diluent can further include a wax, which can provide increased viscosity to a slurry (such as a mineral oil slurry). A wax is a food grade petrolatum also known as petroleum jelly. A wax can be a paraffin wax. Paraffin waxes include SONO JELL® paraffin waxes, such as SONO JELL® 4 and SONO JELL® 9 from Sonneborn, LLC. In at least one embodiment, a slurry has about 5 wt % or greater of wax, such as about 10 wt % or greater, such as about 25 wt % or greater, such as about 40 wt % or greater, such as about 50 wt % or greater, such as about 60 wt % or greater, such as about 70 wt % or greater. For example, a mineral oil slurry can have about 70 wt % mineral oil, about 10 wt % wax, and about 20 wt % supported catalyst(s) (e.g., supported dual catalysts). The increased viscosity provided by a wax in a slurry, such as a mineral oil slurry, provides reduced settling of supported catalyst(s) in a vessel or catalyst pot. Also, using an increased viscosity mineral oil slurry does not inhibit trim efficiency. In at least one embodiment, a wax has a density of about 0.7 g/cm³ (at 100° C.) to about 0.95 g/cm³ (at 100° C.), such as about 0.75 g/cm³ (at 100° C.) to about 0.87 g/cm³ (at 100° C.). A wax can have a kinematic viscosity of about 5 mm²/s (at 100° C.) to about 30 mm²/s (at 100° C.). A wax can have a boiling point of about 200° C. or greater, such as about 225° C. or greater, such as about 250° C. or greater. A wax can have a melting point of about 25° C. to about 100° C., such as about 35° C. to about 80° C.

The catalyst component solution (referred to as the “trim” solution) may include only catalyst compound(s) or may include an activator. In at least one embodiment, the catalyst compound(s) in the catalyst component solution is unsupported. The catalyst solution used in a trim process can be prepared by dissolving the catalyst compound and optional activators in a liquid solvent. The liquid solvent may be an alkane, such as a C₅ to C₃₀ alkane, or a C₅ to C₁₀ alkane. Cyclic alkanes such as cyclohexane and aromatic compounds such as toluene may also be used. Mineral oil may be used as a solvent alternatively or in addition to other alkanes such as a C₅ to C₃₀ alkane. Mineral oil can have a density of about 0.85 g/cm³ to about 0.9 g/cm³ at 25° C. according to ASTM D4052, such as about 0.86 g/cm³ to about 0.88 g/cm³. Mineral oil can have a kinematic viscosity at 25° C. of about 150 cSt to about 200 cSt according to ASTM D341, such as about 160 cSt to about 190 cSt, such as about 170 cSt. Mineral oil can have an average molecular weight of about 400 g/mol to about 600 g/mol according to ASTM D2502, such as about 450 g/mol to about 550 g/mol, such as about 500 g/mol. In at least one embodiment, a mineral oil is HYDROBRITE® 380 PO White Mineral Oil (“HB380”) from Sonneborn, LLC.

The solution employed should be liquid under the conditions of polymerization and relatively inert. In at least one embodiment, the liquid utilized in the catalyst compound solution is different from the diluent used in the catalyst component slurry. In another embodiment, the liquid utilized in the catalyst compound solution is the same as the diluent used in the catalyst component solution.

In alternative embodiments, the catalyst is not limited to a slurry arrangement, as a mixed catalyst system may be made on a support and dried. The dried catalyst system can then be fed to the reactor through a dry feed system.

In gas-phase polyethylene production processes, it may be desirable to use one or more static control agents to aid in regulating static levels in the reactor. As used herein, a static control agent is a chemical composition which, when introduced into a fluidized bed reactor, may influence or drive the static charge (negatively, positively, or to zero) in the fluidized bed. The specific static control agent used may depend upon the nature of the static charge, and the choice of static control agent may vary dependent upon the polymer being produced and the single site catalyst compounds being used.

Control agents such as aluminum stearate may be employed. The static control agent used may be selected for its ability to receive the static charge in the fluidized bed without adversely affecting productivity. Other suitable static control agents may also include aluminum distearate, ethoxylated amines, and anti-static compositions.

### Polyolefin Products

The present disclosure relates to compositions of matter produced by the methods described herein.

In at least one embodiment, a process described herein produces C₂ to C₂₀ olefin homopolymers (e.g., polyethylene; polypropylene), or C₂ to C₂₀ olefin copolymers (e.g., ethylene-octene, ethylene-propylene) and or propylene-alpha-olefin copolymers, such as C₃ to C₂₀ copolymers (such as propylene-hexene copolymers or propylene-octene copolymers).

In at least one embodiment, a polymer of the present disclosure has an Mw about 10,000 g/mol to about 500,000 g/mol, such as about 15,000 g/mol to about 450,000 g/mol, such as about 20,000 g/mol to about 400,000 g/mol, such as about 25,000 g/mol to about 350,000 g/mol, such as about 30,000 g/mol to about 300,000 g/mol.

In at least one embodiment, a polymer of the present disclosure has an Mn about 1,000 g/mol to about 300,000 g/mol, such as about 2,500 g/mol to about 200,000 g/mol, such as about 5,000 g/mol to about 100,000 g/mol, such as about 7,500 g/mol to about 75,000 g/mol, such as about 9,000 g/mol to about 50,000 g/mol.

In at least one embodiment, a polymer of the present disclosure has an Mz about 10,000 g/mol to about 500,000 g/mol, such as about 15,000 g/mol to about 450,000 g/mol, such as about 20,000 g/mol to about 400,000 g/mol, such as about 25,000 g/mol to about 350,000 g/mol, such as about 30,000 g/mol to about 300,000 g/mol. Alternatively, a polymer of the present disclosure can have an Mz greater than 500,000 g/mol, such as about 600,000 g/mol to about 3,000,000 g/mol, such as about 700,000 g/mol to about 2,500,000 g/mol, such as about 800,000 g/mol to about 2,000,000 g/mol, such as about 900,000 g/mol to about 1,500,000 g/mol.

In at least one embodiment, a polymer of the present disclosure has an Mw/Mn (PDI) value about 1 to about 8, such as about 2 to about 7, such as about 3 to about 6.5, such as about 3.5 to about 6, alternatively about 1.5 to about 2.5.

In at least one embodiment, a polymer of the present disclosure can have a Tm (° C.) of about 120° C. to about 150° C., such as about 122.5° C. to about 145° C., about 125° C. to about 140° C., such as about 130° C. to about 135° C.

In at least one embodiment, a polymer of the present disclosure can have a melt index ratio (MIR, I₂₁/I₂) of about 10 to less than 300, or, in many embodiments, about 30 to about 100, such as about 50 to about 80, such as about 55 to 65, alternatively about 65 to about 80. The MIR can be determined according to D1238 (190° C., 21.6 kg load).

In at least one embodiment, a polymer of the present disclosure can have a melt index (MI, I₂) of about 0.1 g/10 minutes to about 20 g/10 minutes, such as about 0.2 g/10 minutes to about 10 g/10 minutes, such as about 0.4 g/10 minutes to about 3 g/10 minutes, such as about 0.6 g/10 minutes to about 1.5 g/10 minutes. The MI can be measured in accordance with ASTM D1238 (190° C., 2.16 kg load).

In at least one embodiment, a polymer of the present disclosure can have a high load melt index (HLMI, I₂₁) of about 0.2 g/10 minutes to about 100 g/10 minutes, such as about 0.5 g/10 minutes to about 5 g/10 minutes, such as about 0.7 g/10 minutes to about 1.5 g/10 minutes, alternatively about 40 g/10 minutes to about 70 g/10 minutes, such as about 50 g/10 minutes to about 60 g/10 minutes, such as about 55 g/10 minutes to about 60 g/10 minutes, as determined by ASTM D1238 (190° C., 21.6 kg load).

In at least one embodiment, a polymer of the present disclosure can have a density of about 0.89 g/cm³, about 0.90 g/cm³, or about 0.91 g/cm³ to about 0.95 g/cm³, about 0.96 g/cm³, or about 0.97 g/cm³. For example, the density can be about 0.94 g/cm³ to about 0.970 g/cm³, such as about 0.946 g/cm³ to about 0.96 g/cm³, such as about 0.948 g/cm³ to about 0.951 g/cm³, alternatively about 0.95 g/cm³ to about 0.96 g/cm³. Density can be determined in accordance with ASTM D792. Density is expressed as grams per cubic centimeter (g/cm³) unless otherwise noted.

In at least one embodiment, a polymer of the present disclosure can have a bulk density of about 0.25 g/cm³ to about 0.5 g/cm³, such as about 0.25 g/cm³ to about 0.4 g/cm³, such as about 0.3 g/cm³ to about 0.4 g/cm³. For example, the bulk density of the polyethylene can be about 0.30 g/cm³, about 0.32 g/cm³, or about 0.33 g/cm³ to about 0.40 g/cm³, about 0.37 g/cm³, or about 0.36 g/cm³. The bulk density can be measured in accordance with ASTM D1895 method B.

Likewise, a process of the present disclosure produces olefin polymers, such as polyethylene and polypropylene homopolymers and copolymers. In at least one embodiment, the polymers produced herein are homopolymers of ethylene or copolymers of ethylene having, for example, about 0.00001 wt % to about 8 wt % (alternately about 0.00001 wt % to about 3 wt %, such as about 0.00001 wt % to about 2 wt %, such as about 0.00001 wt % to about 1.5 wt %, of one or more C₃ to C₂₀ olefin comonomer (such as C₃ to C₁2 alpha-olefin, such as propylene, butene, hexene, octene, decene, dodecene, such as propylene, butene, hexene, octene). In at least one embodiment, the monomer is ethylene and the comonomer is hexene, such as about 0.00001 wt % to about 5 wt % hexene, such as about 0.00001 wt % to about 2 wt % hexene, such as about 0.00001 wt % to about 1.5 wt % hexene, based on the weight of the polymer.

In at least one embodiment, a polymer produced herein has a unimodal or multimodal molecular weight distribution as determined by Gel Permeation Chromatography (GPC). By “unimodal” is meant that the GPC trace has one peak or inflection point. By “multimodal” is meant that the GPC trace has at least two peaks or inflection points. An inflection point is that point where the second derivative of the curve changes in sign (e.g., from negative to positive or vice versus).

### GPC 4-D

Unless otherwise indicated, the distribution and the moments of molecular weight (Mw, Mn, Mz, Mw/Mn, etc.), the comonomer content and the branching index (g′) are determined by using a high temperature Gel Permeation Chromatography (Polymer Char GPC-IR) equipped with a multiple-channel band-filter based Infrared detector IR5 with a multiple-channel band filter based infrared detector ensemble IR5 with band region covering about 2700 cm⁻¹ to about 3000 cm⁻¹(representing saturated C—H stretching vibration), an 18-angle light scattering detector and a viscometer. Three Agilent PLgel 10-μm Mixed-B LS columns are used to provide polymer separation. Reagent grade 1,2,4-trichlorobenzene (TCB) (from Sigma-Aldrich) comprising ˜300 ppm antioxidant BHT can be used as the mobile phase at a nominal flow rate of ˜1.0 mL/minutes and a nominal injection volume of ˜200 μL. The whole system including transfer lines, columns, and detectors can be contained in an oven maintained at ˜145° C. A given amount of sample can be weighed and sealed in a standard vial with ˜10 μL flow marker (heptane) added thereto. After loading the vial in the auto-sampler, the oligomer or polymer may automatically be dissolved in the instrument with ˜8 mL added TCB solvent at ˜160° C. with continuous shaking. The sample solution concentration can be from ˜0.2 to ˜2.0 mg/ml, with lower concentrations used for higher molecular weight samples. The concentration, c, at each point in the chromatogram can be calculated from the baseline-subtracted IR5 broadband signal, I, using the equation: c=aI, where a is the mass constant determined with polyethylene or polypropylene standards. The mass recovery can be calculated from the ratio of the integrated area of the concentration chromatography over elution volume and the injection mass which is equal to the pre-determined concentration multiplied by injection loop volume. The conventional molecular weight (IR MW) is determined by combining universal calibration relationship with the column calibration which is performed with a series of monodispersed polystyrene (PS) standards ranging from 700 to 10 M gm/mole. The MW at each elution volume is calculated with following equation:

$$log M = \frac{log ( {K}_{PS} / K )}{α + 1} + \frac{{α}_{PS} + 1}{α + 1} log {M}_{PS}$$

where the variables with subscript “PS” stand for polystyrene while those without a subscript are for the test samples. In this method, α_{PS}=0.67 and K_{PS}=0.000175, a and K for other materials are as calculated by GPC ONE™ software (Polymer Characterization, S. A., Valencia, Spain). Concentrations are expressed in g/cm³, molecular weight is expressed in g/mole, and intrinsic viscosity (hence K in the Mark-Houwink equation) is expressed in dL/g unless otherwise noted.

The comonomer composition is determined by the ratio of the IR5 detector intensity corresponding to CH₂ and CH₃ channel calibrated with a series of PE and PP homo/copolymer standards whose nominal value are predetermined by NMR or FTIR. In particular, this provides the methyls per 1000 total carbons (CH₃/1000TC) as a function of molecular weight. The short-chain branch (SCB) content per 1000TC (SCB/1000TC) is then computed as a function of molecular weight by applying a chain-end correction to the CH₃/1000TC function, assuming each chain to be linear and terminated by a methyl group at each end. The weight % comonomer is then obtained from the following expression in which f is 0.3, 0.4, 0.6, 0.8, and so on for C₃, C₄, C₆, C₈, and so on co-monomers, respectively:

$$w 2 = f * SCB / 1000 TC$$

The bulk composition of the polymer from the GPC-IR and GPC-4D analyses is obtained by considering the entire signals of the CH₃ and CH₂ channels between the integration limits of the concentration chromatogram. First, the following ratio is obtained

$$Bulk IR ratio = \frac{Area of {CH}_{3} signal within integration limits}{Area of {CH}_{2} signal within integration limits} .$$

Then the same calibration of the CH₃ and CH₂ signal ratio, as mentioned previously in obtaining the CH3/1000TC as a function of molecular weight, is applied to obtain the bulk CH3/1000TC. A bulk methyl chain ends per 1000TC (bulk CH3end/1000TC) is obtained by weight-averaging the chain-end correction over the molecular-weight range. Then

$$w 2 b = f * CH 3 / 1000 TC$$

$$bulk SCB / 1000 TC = bulk CH 3 / 1000 TC - bulk CH 3 end / 1000 TC$$

and bulk SCB/1000TC is converted to bulk w2 in the same manner as described above.

The LS detector is the 18-angle Wyatt Technology High Temperature DAWN HELEOSII. The LS molecular weight (M) at each point in the chromatogram is determined by analyzing the LS output using the Zimm model for static light scattering (Light Scattering from Polymer Solutions; Huglin, M. B., Ed.; Academic Press, 1972.):

$$\frac{{K}_{o} c}{Δ R ( θ )} = \frac{1}{MP ( θ )} + 2 {A}_{2} c . \qquad ( 6 )$$

Here, ΔR(θ) is the measured excess Rayleigh scattering intensity at scattering angle θ, c is the polymer concentration determined from the IR5 analysis, A₂ is the second virial coefficient, P(θ) is the form factor for a monodisperse random coil, and K_{O} is the optical constant for the system:

$${K}_{o} = \frac{4 {π}^{2} {{n}^{2} ( dn / dc )}^{2}}{{λ}^{4} {N}_{A}}$$

where NA is Avogadro's number, and (dn/dc) is the refractive index increment for the system, n=1.500 for TCB at 145° C. and λ=665 nm. For analyzing polyethylene homopolymers, ethylene-hexene copolymers, and ethylene-octene copolymers, dn/dc=0.1048 ml/mg and A2=0.0015; for analyzing ethylene-butene copolymers, dn/dc=0.1048*(1-0.00126*w2) ml/mg and A2=0.0015 where w2 is weight percent butene comonomer.

A high temperature Agilent (or Viscotek Corporation) viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, is, for the solution flowing through the viscometer is calculated from their outputs. The intrinsic viscosity, [η], at each point in the chromatogram is calculated from the equation [η]=ηs/c, where c is concentration and is determined from the IR5 broadband is channel output. The viscosity MW at each point is calculated as M=K_{PS}M^{α}^{_{PS}}⁺¹/[η], where ups is 0.67 and Kₚₛ is 0.000175.

### Blends

In another embodiment, the polymer (such as the polyethylene or polypropylene) produced herein is combined with one or more additional polymers prior to being formed into a film, molded part or other article. Other useful polymers include polyethylene, isotactic polypropylene, highly isotactic polypropylene, syndiotactic polypropylene, random copolymer of propylene and ethylene, and or butene, and or hexene, polybutene, ethylene vinyl acetate, LDPE, LLDPE, HDPE, ethylene vinyl acetate, ethylene methyl acrylate, copolymers of acrylic acid, polymethylmethacrylate or any other polymers polymerizable by a high-pressure free radical process, polyvinylchloride, polybutene-1, isotactic polybutene, ABS resins, ethylene-propylene rubber (EPR), vulcanized EPR, EPDM, block copolymer, styrenic block copolymers, polyamides, polycarbonates, PET resins, cross linked polyethylene, copolymers of ethylene and vinyl alcohol (EVOH), polymers of aromatic monomers such as polystyrene, poly-1 esters, polyacetal, polyvinylidine fluoride, polyethylene glycols, and or polyisobutylene.

In at least one embodiment, the polymer (such as the polyethylene or polypropylene) is present in the above blends, at about 10 wt % to about 99 wt %, based upon the weight of the polymers in the blend, such as about 20 wt % to about 95 wt %, such as at least about 30 wt % to about 90 wt %, such as at least about 40 wt % to about 90 wt %, such as at least about 50 wt % to about 90 wt %, such as at least about 60 wt % to about 90 wt %, such as at least about 70 to about 90 wt %.

Additionally, additives may be included in the blend, in one or more components of the blend, and or in a product formed from the blend, such as a film, as desired. Such additives are well known in the art, and can include, for example: fillers; antioxidants (e.g., hindered phenolics such as IRGANOX™ 1010 or IRGANOX™ 1076 available from Ciba-Geigy); phosphites (e.g., IRGAFOS™ 168 available from Ciba-Geigy); anti-cling additives; tackifiers, such as polybutenes, terpene resins, aliphatic and aromatic hydrocarbon resins, alkali metal and glycerol stearates, and hydrogenated rosins; UV stabilizers; heat stabilizers; anti-blocking agents; release agents; anti-static agents; pigments; colorants; dyes; waxes; silica; fillers; talc.

### Films

Any of the foregoing polymers, or blends thereof, may be used in a variety of end-use applications. Such applications include, for example, mono- or multi-layer blown, extruded, and or shrink films. These films may be formed by any number of well-known extrusion or coextrusion techniques, such as a blown bubble film processing technique, wherein the composition can be extruded in a molten state through an annular die and then expanded to form a uni-axial or biaxial orientation melt prior to being cooled to form a tubular, blown film, which can then be axially slit and unfolded to form a flat film. Films may be subsequently unoriented, uniaxially oriented, or biaxially oriented to the same or different extents. One or more of the layers of the film may be oriented in the transverse and or longitudinal directions to the same or different extents. The uniaxially orientation can be accomplished using suitable cold drawing or hot drawing methods. Biaxial orientation can be accomplished using tenter frame equipment or a double bubble processes and may occur before or after the individual layers are brought together. For example, a polyethylene layer can be extrusion coated or laminated onto an oriented polypropylene layer or the polyethylene and polypropylene can be coextruded together into a film then oriented. Likewise, oriented polypropylene could be laminated to oriented polyethylene or oriented polyethylene could be coated onto polypropylene then optionally the combination could be oriented even further. However, in another embodiment the film is oriented to the same extent in both the MD and TD directions.

The films may vary in thickness depending on the intended application; however, films of a thickness of about 1 μm to about 50 μm can be suitable. Films intended for packaging can be about 10 μm to about 50 μm thick. The thickness of the sealing layer can be about 0.2 μm to about 50 μm. There may be a sealing layer on both the inner and outer surfaces of the film or the sealing layer may be present on only the inner or the outer surface.

### EXAMPLES

“Ether” refers to ethyl ether and “Celite” refers to diatomaceous earth.

Starting materials and reagents: 2,6-Bis(1-(2,6-dimethylphenylimino)ethyl)pyridine was prepared as described in J Am. Chem. Soc. 1998, 120 (16), pp. 4049-4050. [2,6-Bis(1-(2,6-dimethylphenylimino)ethyl)pyridine]iron dichloride was prepared as described in J. Am. Chem. Soc. 1998, 120 (16), pp. 4049-4050 using anhydrous iron dichloride. Lithium diisopropylamide (LDA) was prepared as described in Org. Synth. 1986, 64, 68. Silica-alumina catalyst support (grade 135) was purchased from MilliporeSigma.

The following catalysts were synthesized:

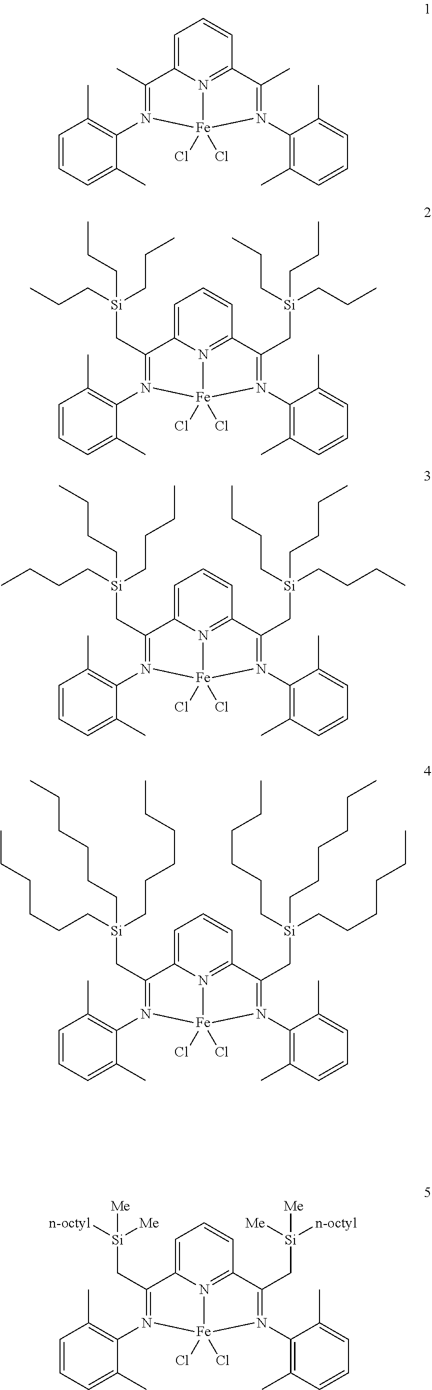

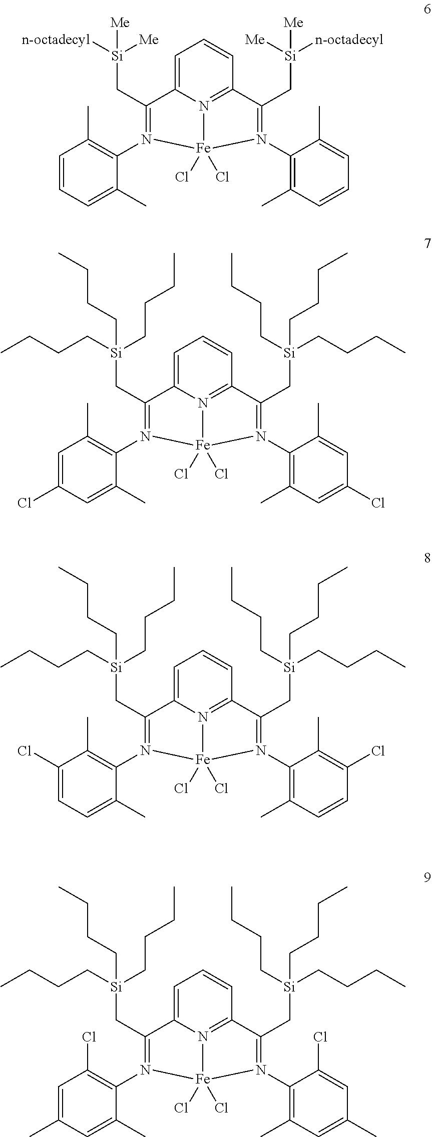

### Preparation of Ligands and Ligand Components

### General Procedure I. Imine Condensation

2,6-Diacetylpyridine (1.00 g, 6.13 mmol), aniline (15.3 mmol), silica-alumina catalyst support (mass equal to 50% of the total mass of 2,6-diacetylpyridine and aniline) and dried 3A molecular sieves (3.5 g) were combined in toluene (10 mL). The reaction mixture was stirred at 60° C. for 16 hours. The reaction mixture was then filtered through a silica pad, which was washed with dichloromethane to ensure that all product had been eluted. The filtrate was concentrated under vacuum, and the resulting crude product was stirred in ethanol (10 mL) for 3 hours. The pure product was then isolated as a solid by filtration.

### 2,6-Bis(1-(4-chloro-2,6-dimethylphenylimino)ethyl)pyridine

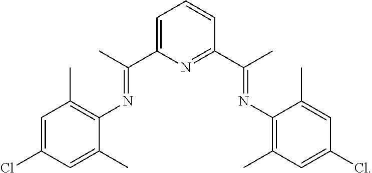 [SMILES: C/C(=N\c1c(C)cc(Cl)cc1C)c1cccc(/C(C)=N/c2c(C)cc(Cl)cc2C)n1]

Prepared according to General Procedure I using 4-chloro-2,6-dimethyl-aniline (2.38 g, 15.3 mmol), the product was isolated as a yellow solid (1.53 g, 74%). ¹H NMR (400 MHz, CDCl₃) δ 8.46 (d, J=7.7 Hz, 2H), 7.93 (t, J=7.8 Hz, 1H), 7.08 (s, 4H), 2.23 (s, 6H), 2.02 (s, 12H).

### 2,6-Bis(1-(3-chloro-2,6-dimethylphenylimino)ethyl)pyridine

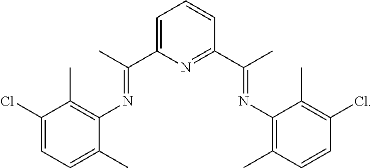 [SMILES: C/C(=N\c1c(C)ccc(Cl)c1C)c1cccc(/C(C)=N/c2c(C)ccc(Cl)c2C)n1]

Prepared according to General Procedure I using 3-chloro-2,6-dimethyl-aniline (2.38 g, 15.3 mmol), the product was isolated as a yellow solid (1.44 g, 54%). ¹HNMR (400 MHz, CDCl₃) δ 8.51 (d, J=7.8 Hz, 2H), 7.97 (td, 1=7.9, 1.8 Hz, 1H), 7.06 (q, 0.1=8.2 Hz, 4H), 2.32-2.21 (m, 6H), 2.13 (d, J=1.8 Hz, 6H), 2.04 (s, 6H).

### 2,6-Bis(1-(2-chloro-4,6-dimethylphenylimino)ethyl)pyridine

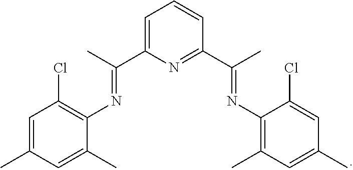

Prepared according to General Procedure I using 2-chloro-4,6-dimethyl-aniline (2.20 g, 14.1 mmol), the product was isolated as a yellow solid (0.64 g, 24%). ¹H NMR (400 MHz, CDCl₃) δ 8.49 (d, J=7.8 Hz, 2H), 7.92 (t, J=7.8 Hz, 1H), 7.11 (s, 2H), 6.96 (s, 2H), 2.31 (s, 6H), 2.30 (s, 6H), 2.07 (s, 6H).

### General Procedure II: Silylation

Solutions of 2,6-bis(1-(2,6-dimethylphenylimino)ethyl)pyridine (1.00 g, 2.71 mmol) in THF (4 mL) and freshly prepared lithium diisopropylamide (LDA) (0.594 g, 5.55 mmol) in THE (3 mL) were separately cooled in a cooling bath below −55° C. for 10 minutes. The chilled LDA solution was then slowly added to the solution of 2,6-bis(1-(2,6-dimethylphenylimino)ethyl)pyridine, which was then stirred at −55° C. for 1 hour. Silyl chloride (5.41 mmol) was then added to the reaction mixture, which was stirred at ambient temperature for 2 hours. The reaction was then quenched with water and diluted with hexane. After separating the two phases, the aqueous phase was extracted with dichloromethane (2×10 mL). The combined organic extracts were dried over MgSO₄, then concentrated to dryness. The crude product was precipitated from ethanol (10 mL) and the resulting mixture was cooled at −20° C. for 2 hours. The purified product was collected by filtration, washed with cold ethanol, and dried under vacuum.

### 2,6-Bis(1-(2,6-dimethylphenylimino)-2-(tripropylsilyl)ethyl)pyridine

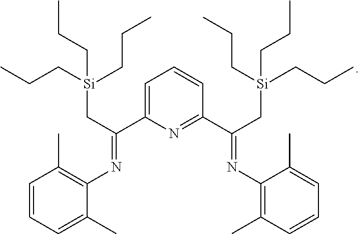 [SMILES: CCC[Si](CCC)(CCC)C/C(=N\c1c(C)cccc1C)c1cccc(/C(C[Si](CCC)(CCC)CCC)=N/c2c(C)cccc2C)n1]

Prepared according to General Procedure II using tripropyl(chloro)silane (1.04 g, 5.41 mmol), the product was isolated as a yellow solid (1.60 g, 77%). ¹HNNMR (400 MHz, CDCl₃) δ 8.38 (d, J=7.8 Hz, 2H), 7.90 (t, J=7.8 Hz, 1H), 7.07 (d, J=7.5 Hz, 4H), 6.92 (t, J=7.5 Hz, 2H), 2.61 (s, 4H), 2.15 (s, 12H), 1.09-0.90 (m, 12H), 0.74 (t, J=7.3 Hz, 18H), 0.38-0.17 (m, 12H).

### 2,6-Bis(1-(2,6-dimethylphenylimino)-2-(tributylsilyl)ethyl)pyridine

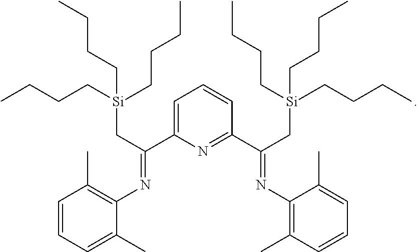 [SMILES: CCCC[Si](CCCC)(CCCC)C/C(=N\c1c(C)cccc1C)c1cccc(/C(C[Si](CCCC)(CCCC)CCCC)=N/c2c(C)cccc2C)n1]

Prepared according to General Procedure II using tributyl(chloro)silane (1.27 g, 5.41 mmol), the product was isolated as a yellow solid (1.53 g, 74%). ¹HNMR (400 MHz, CDCl₃) δ 8.40 (dd, J=7.8, 1.7 Hz, 2H), 7.89 (t, J=7.5 Hz, 1H), 7.07 (d, J=7.5 Hz, 4H), 6.92 (t, J=7.6 Hz, 2H), 2.62 (s, 4H), 2.14 (s, 12H), 1.09 (q, J=7.3 Hz, 12H), 1.00-0.82 (m, 12H), 0.78-0.62 (m, 18H), 0.36-0.20 (m, 12H).

### 2,6-Bis(1-(2,6-dimethylphenylimino)-2-(trihexylsilyl)ethyl)pyridine

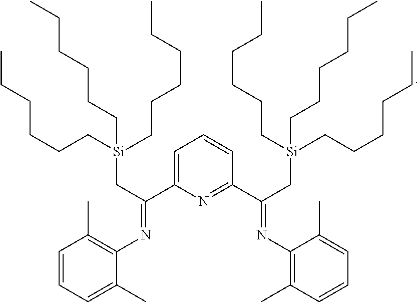 [SMILES: CCCCCC[Si](CCCCCC)(CCCCCC)C/C(=N\c1c(C)cccc1C)c1cccc(/C(C[Si](CCCCCC)(CCCCCC)CCCCCC)=N/c2c(C)cccc2C)n1]

Solutions of 2,6-bis(1-(2,6-dimethylphenylimino)ethyl)pyridine (0.500 g, 1.35 mmol) in THE (2 mL) and freshly prepared lithium diisopropylamide (LDA) (0.290 g, 2.71 mmol) in THF (2 mL) were separately cooled in a cooling bath below −55° C. for 10 minutes. The chilled LDA solution was then slowly added to the solution of 2,6-bis(1-(2,6-dimethylphenylimino)ethyl)pyridine, which was stirred at −55° C. for 1 hour. Trihexyl(chloro)silane (0.907 g, 2.84 mmol) was then added to the reaction mixture, which was stirred at ambient temperature for 2 hours. The reaction was then quenched with water and diluted with hexane. After separating the two phases, the aqueous phase was extracted with dichloromethane (2×10 mL). The combined organic extracts were dried over MgSO₄, then concentrated to dryness. The crude product (1.31 g, 95%) was used without further purification. ¹H NMR (400 MHz, CDCl₃) δ 8.39 (d, J=7.8 Hz, 2H), 7.88 (t, J=7.8 Hz, 1H), 7.06 (d, J=7.5 Hz, 4H), 6.96-6.81 (m, 2H), 2.60 (s, 4H), 2.14 (s, 12H), 1.38-1.14 (m, 18H), 1.13-1.00 (m, J=5.0, 4.0 Hz, 22H), 0.99-0.76 (m, 26H), 0.37-0.19 (m, 12H).

### 2,6-Bis(1-(2,6-dimethylphenylimino)-2-(dimethyloctylsilyl)ethyl)pyridine

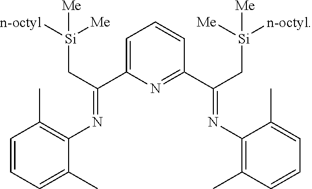

Prepared according to General Procedure 11 using dimethyloctyl(chloro)silane (1.12 g, 5.41 mmol), the product was isolated as a red oil (1.63 g, 85%). ¹H NMR (400 MHz, CDCl₃) δ 8.37 (d, J=7.8 Hz, 2H), 7.89 (t, J=7.8 Hz, 1H), 7.06 (d, J=7.5 Hz, 4H), 6.92 (t, J=7.5 Hz, 2H), 2.56 (s, 4H), 2.12 (s, 12H), 1.39-0.92 (m, 28H), 0.87 (t, J=7.0 Hz, 6H), 0.43-0.22 (m, 4H), -0.24 (s, 12H).

### 2,6-Bis(1-(2,6-dimethylphenylimino)-2-(dimethyloctadecylsilyl)ethyl)pyridine

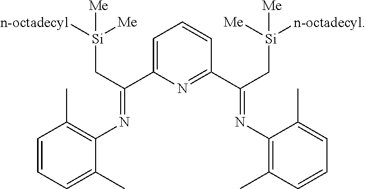

Prepared according to General Procedure II using dimethyloctadecyl(chloro)silane (1.88 g, 5.41 mmol), the product was isolated as a red oil (2.37 g, 88%). ¹H NMR (400 MHz, CDCl₃) δ 8.37 (dd, J=7.8, 1.9 Hz, 2H), 7.90 (t, J=7.5 Hz, 1H), 7.07 (d, J=7.6 Hz, 4H), 6.93 (t, J=7.7 Hz, 2H), 2.56 (s, 4H), 2.12 (s, 12H), 1.34-0.97 (s, 70H), 0.94-0.77 (m, 6H), 0.39-0.25 (m, 4H), -0.24 (s, 12H).

### 2,6-Bis(1-(4-chloro-2,6-dimethylphenylimino)-2-(tributylsilyl)ethyl)pyridine

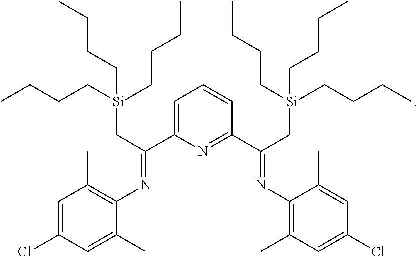 [SMILES: CCCC[Si](CCCC)(CCCC)C/C(=N\c1c(C)cc(Cl)cc1C)c1cccc(/C(C[Si](CCCC)(CCCC)CCCC)=N/c2c(C)cc(Cl)cc2C)n1]

Prepared according to General Procedure II using 2,6-bis(1-(4-chloro-2,6-dimethylphenylimino)ethyl)pyridine (1.19 g, 2.71 mmol) and tributyl(chloro)silane (1.28 g, 5.43 mmol), the product was isolated as a yellow solid (1.34 g, 59%). ¹H NMR (400 MHz, CDCl₃) δ 8.37 (d, J=7.9 Hz, 2H), 7.90 (t, J=7.8 Hz, 1H), 7.07 (s, 4H), 2.60 (s, 4H), 2.11 (s, 12H), 1.09 (q, J=7.3 Hz, 12H), 0.90 (h, J=7.0, 6.4 Hz, 12H), 0.81-0.64 (m, 18H), 0.39-0.17 (m, 12H).

### 2,6-Bis(1-(3-chloro-2,6-dimethylphenylimino)-2-(tributylsilyl)ethyl)pyridine

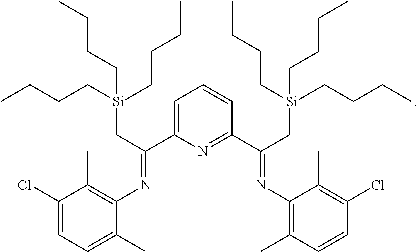 [SMILES: CCCC[Si](CCCC)(CCCC)C/C(=N\c1c(C)ccc(Cl)c1C)c1cccc(/C(C[Si](CCCC)(CCCC)CCCC)=N/c2c(C)ccc(Cl)c2C)n1]

Prepared according to General Procedure II using 2,6-bis(1-(3-chloro-2,6-dimethylphenylimino)ethyl)pyridine (1.18 g, 2.69 mmol) and tributyl(chloro)silane (1.26 g, 5.38 mmol), the product was isolated as a yellow solid (1.38 g, 61%). ¹H NMR (400 MHz, CDCl₃) δ 8.40 (d, J=7.7 Hz, 2H), 7.92 (t, J=7.8 Hz, 1H), 7.02 (q, J=8.2 Hz, 4H), 2.78 (d, J=11.2 Hz, 1H), 2.41 (d, J=11.1 Hz, 1H), 2.20 (d, J=9.3 Hz, 6H), 2.09 (d, J=9.1 Hz, 6H), 1.10 (q, J=7.3 Hz, 12H), 1.02-0.84 (m, 12H), 0.73 (t, J=7.2 Hz, 18H), 0.43-0.10 (m, 12H).

### 2,6-Bis(1-(2-chloro-4,6-dimethylphenylimino)-2-(tributylsilyl)ethyl)pyridine

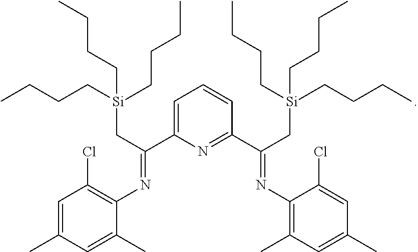 [SMILES: CCCC[Si](CCCC)(CCCC)C/C(=N\c1c(C)cc(C)cc1Cl)c1cccc(/C(C[Si](CCCC)(CCCC)CCCC)=N/c2c(C)cc(C)cc2Cl)n1]

Prepared according to General Procedure II using 2,6-Bis(1-(2-chloro-4,6-dimethylphenylimino)ethyl)pyridine (0.635 g, 1.45 mmol) and tributyl(chloro)silane (0.68 g, 2.90 mmol), the crude product was obtained as an oil. The oil was triturated with methanol several times to afford a solid, which was subsequently stirred in methanol (10 mL) for 3 hours. The pure product was isolated by filtration as a yellow solid (0.91 g, 75%). ¹H NMR (400 MHz, CDCl₃) δ 8.41 (d, J=7.8 Hz, 2H), 7.89 (t, J=7.8 Hz, 1H), 7.10 (s, 2H), 6.94 (s, 2H), 2.84-2.49 (m, 4H), 2.29 (s, 6H), 2.14 (d, J=3.4 Hz, 6H), 1.09 (p, J=7.3 Hz, 12H), 0.92 (dt, J=14.9, 7.9 Hz, 12H), 0.73 (t, J=7.2 Hz, 18H), 0.33 (tt, J=15.2, 6.5 Hz, 12H).

### Preparation of Transition Metal Catalysts 2 Through 9

### General Procedure:

The ligand (1.00 equiv) and iron dichloride (1.00 equiv) were combined in THE (5 mL). The resulting mixture was stirred for 10 hours at ambient temperature. The reaction solution was then concentrated under vacuum to afford the iron catalyst as a blue solid. All catalysts were obtained in quantitative yield.

### Solubility of Catalysts

General considerations: Solubility studies for all catalysts were performed using material as synthesized, unless otherwise noted. Solvents used were sparged with nitrogen (30-60 minutes) and dried over 3 Å mole sieves. Unless stated otherwise, all measurements were performed at ambient temperature (20-25° C.).

### General Procedure:

A measured mass of solvent was added to a known amount of catalyst. After stirring for at least 30 minutes or more, the resulting mixture was filtered. The filtrate was concentrated is to dryness, and the remaining catalyst was weighed to provide the mass of dissolved catalyst. Solubility was calculated using the formula below.

Alternatively, for mixtures prepared at a low concentration (<0.25 wt %) which remained heterogeneous (visible solids or murky), the value may be reported as being “less than” the calculated value.

Formula used to calculate solubility is listed below.

$$Solubility ( wt \% ) = 100 \% \times \frac{mass of dissolved complex}{mass of dissolved complex + mass of solvent} .$$

TABLE 1
Solubility of catalysts in isohexane at ambient temperature.

| Catalyst | Solvent | Solubility (wt %) |
|---|---|---|
| 1 | | |
| 2 | isohexane | 0.3 |
| 3 | isohexane | 4.2 |
| 4 | | |
| 5 | | |
| 6 | isohexane | <0.2 |
| 7 | pentane | 2.6 |
| 8 | pentane | 1.7 |
| 9 | pentane | 0.15 |

### Catalyst Supportation

### General Considerations and Reagents:

All manipulations were performed under an inert atmosphere using glove box techniques unless otherwise stated. Toluene and Pentane (Sigma Aldrich) were degassed and dried over 3A molecular sieves overnight prior to use, as reported in D. Bradley, et al., J. Org. Chem. 2010, 75, 8351. Methylaluminoxane (MAO) was purchased from Grace and used as received.

### Supportation of Catalyst 3

In a Celestir™ vessel, MAO (42.5 g, 30 wt % in toluene) and toluene (200 mL) were combined. The solution was stirred for two minutes. A solution of Catalyst 3 (1069 mg) in toluene (50 mL) was then slowly added dropwise to the solution of MAO. The reaction mixture was stirred for an hour at ambient temperature. ES70 875 silica (35.2 g) was subsequently added to the reaction mixture, which was then stirred for another hour. The solids were then collected by filtration, washed with pentane (200 mL), and dried under vacuum for 8 hours, to yield supported Catalyst 3.

### Supportation of Catalyst 7

In a Celestir™ vessel, MAO (0.8 g, 30 wt % in toluene) and toluene (25 mL) were combined. The solution was stirred for two minutes. A solution of Catalyst 7 (38.5 mg) in toluene (10 mL) was then slowly added dropwise to the solution of MAO. The reaction mixture was stirred for an hour at ambient temperature. ES70 875 silica (0.76 g) was subsequently added to the reaction mixture, which was then stirred for another hour. The solids were then collected by filtration, washed with pentane (50 mL), and dried under vacuum for 3 hours, to yield supported Catalyst 7.

### Supportation of Catalyst 8

In a Celestir™ vessel, MAO (0.8 g, 30 wt % in toluene) and toluene (25 mL) were combined. The solution was stirred for two minutes. A solution of Catalyst 8 (38.5 mg) in toluene (10 mL) was then slowly added dropwise to the solution of MAO. The reaction mixture was stirred for an hour at ambient temperature. ES70 875 silica (0.76 g) was subsequently added to the reaction mixture, which was then stirred for another hour. The solids were then collected by filtration, washed with pentane (50 mL), and dried under vacuum for 3 hours, to yield supported Catalyst 8.

### Supportation of Catalyst 9 for 2 L Autoclave

In a Celestir™ vessel, MAO (0.8 g, 30 wt % in toluene) and toluene (25 mL) were combined. The solution was stirred for two minutes. A solution of Catalyst 9 (38.5 mg) in toluene (10 mL) was then slowly added dropwise to the solution of MAO. The reaction mixture was stirred for an hour at ambient temperature. ES70 875 silica (0.76 g) was subsequently added to the reaction mixture, which was then stirred for another hour. The solids were then collected by filtration, washed with pentane (50 mL), and dried under vacuum for 3 hours, to yield supported Catalyst 9 for polymerization in a 2L autoclave.

### Supportation of Catalyst 9 for Gas-Phase Fluidized Bed Reactor

In a Celestir™ vessel, MAO (42.5 g, 30 wt % in toluene) and toluene (200 mL) were combined. The solution was stirred for two minutes. A solution of Catalyst 9 OMC 6131 (1.015 g) in toluene (25 mL) was then slowly added dropwise to the solution of MAO. The reaction mixture was stirred for an hour at ambient temperature. ES70 875 silica (35.24 g) was subsequently added to the reaction mixture, which was then stirred for another hour. The solids were then collected by filtration, washed with pentane (100 mL), and dried under vacuum for 12 hours, to yield supported Catalyst 9 for polymerization in a gas-phase fluidized bed reactor.

### Polymerization Examples

### Preparation of Scavenger (Trimethylaluminum on Silica):

ES70 silica (PQ Corp) was dried for 3 hours at 100° C. in a tube furnace under a slight flow of dry N₂. To a 4 L conical reaction vessel was added 850 g of silica and 4 L of dry, deoxygenated n-pentane. While stirred at 120 rpm, 250 grams of trimethylaluminum was added dropwise over 30 min. The solution was stirred at 120 rpm for 2 hours. The solvent was removed overnight in vacuo at room temperature. The product was removed from the mixer and rinsed with 2 L of pentane on a filter frit. The product was placed back in the mixer to dry in vacuo at room temperature for 4 hours.

### Polymerizations in 2 L Autoclave:

A 2 L autoclave was heated to 110° C. and purged with N₂ for at least 30 minutes. The reactor was then charged with dry NaCl (150 g; Fisher, S271-10) and scavenger (trimethylaluminum on silica, 3 g) and heated for 30 minutes at 85° C. 1-Hexene (2.5 mL) and 10% H₂ in N₂ (120 SCCM) were added, and stirring was then commenced (450 RPM). Supported catalyst was injected into the reactor with ethylene at a pressure of 220 psig. After the injection, the reactor temperature was controlled at 85° C. and ethylene was allowed to flow into the reactor to maintain constant pressure. Both hydrogen and 1-hexene were fed into the reactor as constant ratios to ethylene flow, 0.5 mg/g and 0.1 g/g, respectively. Hydrogen and ethylene ratios were measured by on-line GC analysis. The polymerization was halted after 60 minutes by venting the reactor. The polymer was washed twice with water to remove the salt, then dried in air for at least two days. Catalyst productivities observed for select catalysts are shown in Table 2.

TABLE 2

| | | | | Catalyst |
|---|---|---|---|---|
| | Catalyst | Polymer | | Productivity |
| Catalyst | amount | produced | | (gP/gCat/h) |
| 7 | 32.3 mg | 13.9 | g | 430 |
| 8 | 30.7 mg | 12 | g | 391 |
| 9 | 32.8 mg | 32.4 | g | 988 |

### Polymerization in Gas-Phase Fluidized Bed Reactor:

Polymerization was performed in a 7 foot tall gas-phase fluidized bed reactor with a 4 foot tall 6″ diameter body and a 3 foot tall 10″ diameter expanded section. Cycle and feed gases were fed into the reactor body through a perforated distributor plate, and the reactor was controlled at 300 psi and 70 mol % ethylene. Reactor temperature was maintained by heating the cycle gas. Supported catalyst was fed as a 10 wt % slurry in Sono Jell® from Sonnebom (Parsippany, NJ). The slurry was delivered to the reactor by nitrogen and isopentane feeds in a ⅛″ diameter catalyst probe. Polymer was collected from the reactor as necessary to maintain the desired bed weight. Average process conditions for the polymer collection and corresponding product data are shown in Table 3.

TABLE 3

| Run Condition # | 1 | 2 |
|---|---|---|
| Catalyst | 3 | 9 |
| PROCESS DATA | | |
| H₂ conc. (mol ppm) | 900 | 744 |
| C₆/C₂ Ratio (mol %/mol %) | 0.030 | 0.010 |
| C₂ conc. (mol %) | 70.0 | 69.8 |
| H₂/C₂ Ratio | 12.9 | 10.6 |
| Reactor Temp (F.) | 175 | 185 |
| Residence Time (hr) | 7.1 | 9.2 |
| Catalyst Feed (g/hr) | 0.279 | 0.300 |
| Cat Activity (g poly/g cat) | 1128 | 819 |
| Product Data | | |
| Melt Index (MI) | | 0.85 |
| HLMI | 0.99 | 58.06 |
| HLMI/MI Ratio | | 68.63 |
| Gradient Density | 0.9499 | 0.9572 |
| Bulk Density | 0.3443 | 0.3538 |

Overall, catalyst compounds of the present disclosure can provide enhanced solubility and capability of forming polymers at desirable catalyst activities and the polymers having a high density.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

While the present disclosure has been described with respect to a number of embodiments and examples, those skilled in the art, having benefit of this disclosure, will appreciate that other embodiments can be devised which do not depart from the scope and spirit of the present disclosure.

What is claimed is:

1. A compound represented by Formula (I): 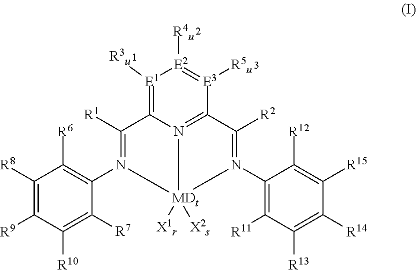
wherein:
M is a Period 4 transition metal;
each of R¹ and R² is independently (i) hydrogen, (ii) C₁-C₄₀ hydrocarbyl, (iii) five-, or six- or seven-membered heterocyclic ring comprising at least one atom selected from the group consisting of N, P, O and S, or (iv) —(R¹⁸)_{q}A(R¹⁹)(R²⁰)(R²¹); wherein each of R¹ and R² is optionally substituted with halogen, —OR¹⁶, or —NR¹⁷²;
each of R³, R⁴, R⁵, R⁸, R⁹, R¹⁰, R¹³, R¹⁴, and R¹⁵ is (i) independently hydrogen, (ii) C₁-C₄₀ hydrocarbyl, (iii) —OR¹⁶, (iv) —NR¹⁷₂, (v) halogen, (vi) five-, six-, or seven-membered heterocyclic ring comprising at least one atom selected from the group consisting of N, P, O and S, or (vii) —(R¹⁸)_{q}A(R¹⁹)(R²⁰)(R²¹); wherein R³, R⁴, R⁵, R⁸, R⁹, R¹⁰, R¹³, R¹⁴, and R¹⁵ are optionally substituted with halogen, —OR¹⁶, or —NR¹⁷₂;
each of R⁶, R⁷, R¹¹, and R¹² is independently (i) hydrogen, (ii) C₁-C₄₀ hydrocarbyl, or (iii) a heteroatom or a heteroatom-containing group; wherein R⁶, R⁷, R¹¹, and R¹² are optionally substituted with halogen, —OR¹⁶, or —NR¹⁷₂;
wherein R¹ optionally is bonded to R³, R² optionally is bonded to R⁵, R³ optionally is bonded to R⁴, R⁴ optionally is bonded to R⁵, R⁷ optionally is bonded to R¹⁰, R¹⁰ optionally is bonded to R⁹, R⁹ optionally is bonded to R⁸, R⁸ optionally is bonded to R⁶, R¹⁵ optionally is bonded to R¹⁴, R¹⁴ optionally is bonded to R¹³, R¹³ optionally is bonded to R¹¹, R¹⁵ optionally is bonded to R¹², in each case to independently form a five-, six-, or seven-membered carbocyclic or heterocyclic ring, the heterocyclic ring comprising at least one atom from the group consisting of N, P, O and S;
each of R¹⁶ and R¹⁷ is independently hydrogen, oxygen, C₁-C₂₂ alkyl, C₂-C₂₂ alkenyl, or C₆-C₂₂ aryl, wherein each R¹⁶ and R¹⁷ is independently optionally substituted with halogen, or two R¹⁶ radicals optionally bond to form a five- or six-membered ring, or two R¹⁷ radicals optionally bond to form a five- or six-membered carbocyclic or heterocyclic ring, the heterocyclic ring comprising at least one atom from the group consisting of N, P, O and S;
at least one of R¹, R², R³, R⁴, R⁵, R⁶, R⁷, R⁸, R⁹, R¹⁰, R¹¹, R¹², R¹³, R¹⁴, and R¹⁵ is —(R¹⁸)_{q}A(R¹⁹)(R²⁰)(R²¹), wherein: A is Si or Ge; R¹⁸ is C₁-C₁₀ hydrocarbyl; each of R¹⁹, R²⁰, and R²¹ is independently C₁-C₄₀ hydrocarbyl, and q is 0 or 1; wherein R¹⁹ optionally is bonded to R²⁰, R²⁰ optionally is bonded to R²¹, and R¹⁹ optionally is bonded to R²¹, in each case to independently form a five-, six-, or seven-membered carbocyclic or heterocyclic ring, the heterocyclic ring comprising at least one atom from the group consisting of N, P, O and S;
each of E¹, E², and E³ is independently carbon, nitrogen or phosphorus;
u¹ is 0 if E¹ is nitrogen or phosphorus, u² is 0 if E² is nitrogen or phosphorus, u³ is 0 if E³ is nitrogen or phosphorus, u¹ is 1 if E¹ is carbon, u² is 1 if E² is carbon, and u³ is 1 if E³ is carbon,
each of X¹ and X² is independently an anionic ligand, wherein X¹ optionally is bonded to X² to form a five-, six-, or seven-membered carbocyclic or heterocyclic ring, the heterocyclic ring comprising at least one atom from the group consisting of N, P, O and S;
r is 1 or 2;
s is 0 to 2;
D is a neutral donor;
t is 0 to 2; and
the sum of r, s, and t is 3 or less.

2. The compound of claim 1, wherein M is Fe.

3. The compound of claim 2, wherein each of X¹ and X² is a halide.

4. The compound of claim 2, wherein:
each of E¹, E², and E³ is carbon,
each of u¹, u², and u³ is 1,
r is 1,
s is 1, and
t is 0.

5. The compound of claim 4, wherein each of R¹, R², R³, R⁴, R⁵, R⁶, R⁷, R⁸, R⁹, R¹⁰, R¹¹, R¹², R¹³, R¹⁴, and R¹⁵ is independently hydrogen, C₁-C₂₂ alkyl, —(R¹⁸)_{q}A(R¹⁹)(R²⁰)(R²¹), fluorine, chlorine, or bromine.

6. The compound of claim 5, wherein each of R¹ and R² is —(R¹⁸)_{q}A(R¹⁹)(R²⁰)(R²¹).

7. The compound of claim 6, wherein:
each instance of A is Si;
each instance of q is 1; and
each instance of R¹⁸ is methylene.

8. The compound of claim 7, wherein, for each instance of R¹⁹, R²⁰, and R²¹ the R¹⁹, R²⁰, and R²¹ of each such instance together have at least ten carbon atoms.

9. The compound of claim 8, wherein each R¹⁹, R²⁰, and R²¹ is independently C₄-C₄₀ alkyl.

10. The compound of claim 9, wherein each instance of —(R¹⁸)_{q}A(R¹⁹)(R²⁰)(R²¹) is independently selected from the group consisting of:
(tributylsilyl)methyl-, (tripentylsilyl)methyl-, (trihexylsilyl)methyl-, (triheptylsilyl)methyl-, (trioctylsilyl)methyl-, (trinonylsilyl)methyl-, (decyl)₃(silyl)methyl-, (dimethyl)(n-decyl)silylmethyl-, (diethyl)(n-decyl)silylmethyl-, (dimethyl)(n-undecyl)silylmethyl-, (diethyl)(n-undecyl)silylmethyl-, (dimethyl)(n-dodecyl)silylmethyl-, (diethyl)(n-dodecyl)silylmethyl-, (dimethyl)(n-tridecyl)silylmethyl-, (diethyl)(n-tridecyl)silylmethyl-, (dimethyl)(n-tetradecyl)silylmethyl-, (diethyl)(n-tetradecyl)silylmethyl-, (dimethyl)(n-pentadecyl)silylmethyl-, (diethyl)(n-pentadecyl)silylmethyl-, (dimethyl)(n-hexadecyl)silylmethyl-, (diethyl)(n-hexadecyl)silylmethyl-, (dimethyl)(n-heptadecyl)silylmethyl-, (diethyl)(n-heptadecyl)silylmethyl-, (dimethyl)(n-octadecyl)silylmethyl-, (diethyl)(n-octadecyl)silylmethyl-, (dimethyl)(n-nonadecyl)silylmethyl-, (diethyl)(n-nonadecyl)silylmethyl-, (dimethyl)(icosyl)silylmethyl-, and (diethyl)(icosyl)methyl-.

11. The compound of claim 1, wherein the compound is selected from the group consisting of:

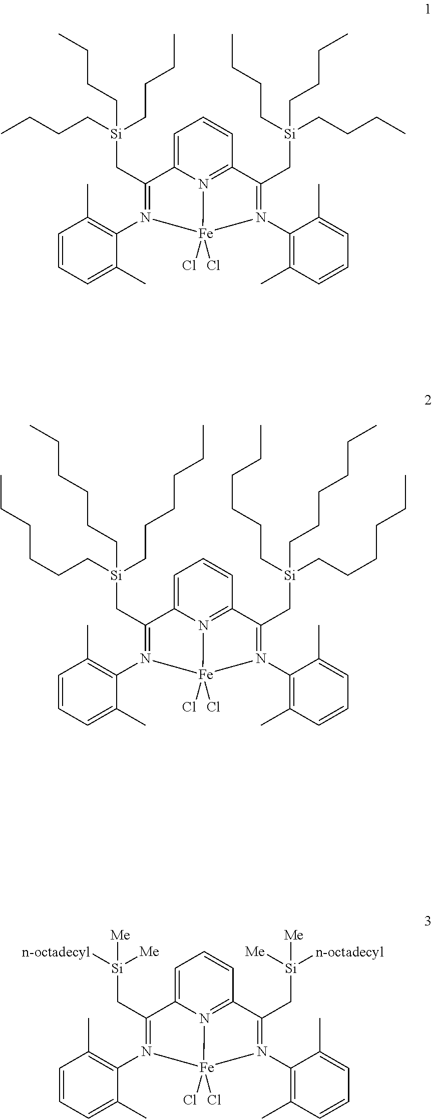

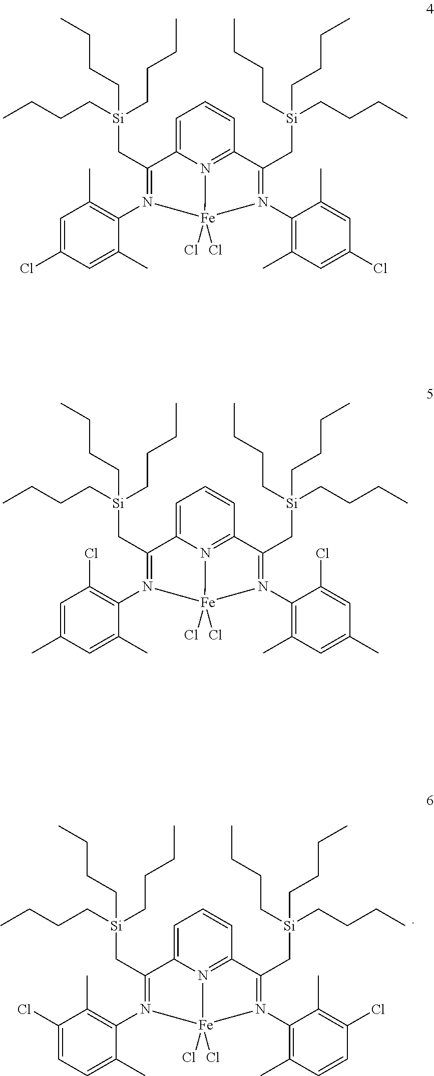

12. A catalyst system comprising an activator and the compound of claim 1.

13. The catalyst system of claim 12, further comprising a support material.

14. The catalyst system of claim 13, wherein the support material is selected from the group consisting of Al₂O₃, ZrO₂, SiO₂, SiO₂/Al₂O₃, SiO₂/TiO₂, silica clay, silicon oxide/clay, and mixtures thereof.

15. The catalyst system of claim 12, wherein the activator comprises a non-coordinating anion activator.

16. The catalyst system of claim 12, wherein the activator comprises an alkylalumoxane.

17. A process for producing an ethylene alpha-olefin copolymer, the process comprising: polymerizing ethylene and at least one C₃-C₂₀ alpha-olefin by introducing the ethylene and the at least one C₃-C₂₀ alpha-olefin with the catalyst system of claim 12, in a reactor, at a reactor pressure of 0.05 MPa to 1,500 MPa and a reactor temperature of 30° C. to 230° C. to form an ethylene alpha-olefin copolymer.

18. The process of claim 17, wherein the catalyst system has a catalyst activity of about 700 gP/gCat to about 1,500 gP/gCat.

19. The process of claim 17, wherein the catalyst system has a catalyst productivity of about 900 gP/gCat/hr to about 1,100 gP/gCat/hr.

20. The process of claim 17, wherein the ethylene alpha-olefin copolymer has a density of about 0.948 g/cm³ to about 0.96 g/cm³.

21. The process of claim 17, wherein the catalyst system further comprises a second compound represented by Formula (I) or a metallocene catalyst compound.

22. The process of claim 21, wherein the ethylene alpha-olefin is multimodal.

23. The process of claim 21, wherein the reactor is a gas-phase fluidized bed reactor and the process further comprises forming the catalyst system by:
contacting a first composition and a second composition in a line coupled with at least one of the reactors to form a third composition, wherein:
the first composition comprises the activator, the compound the second compound, a wax, and a diluent,
the second composition comprises the second compound and a second diluent; and
introducing the third composition from the line into the gas-phase fluidized bed reactor.
